(19) United States
(12) Patent Application Publication
(10) Pub. No.: US 2026/0064232 A1
(43) Pub. Date: Mar. 5, 2026

(54) INFORMATION PROCESSING APPARATUS AND CONTROL METHOD

(71) Applicant: Lenovo (Singapore) Pte. Ltd., Singapore (SG)

(72) Inventor: Yoshinori Ito, Kanagawa (JP)

(73) Assignee: Lenovo (Singapore) Pte. Ltd., Singapore (SG)

(21) Appl. No.: 18/973,631

(22) Filed: Dec. 9, 2024

(30) Foreign Application Priority Data
Aug. 28, 2024 (JP) 2024-146852

(51) Int. Cl. G06F 3/0481

(52) U.S. Cl. CPC G06F 3/0481

(57) ABSTRACT

An information processing apparatus includes a display, and a processor configured to perform control of displaying windows of an application on the display. The processor is configured to perform a screen layout change process of changing a layout of an area in which one or a plurality of the windows are displayable, within a screen area of the display, a storage process of storing position information for each window before the layout of the screen area is changed, a management process of managing a Z-order of the one or the plurality of windows arranged in the screen area of the display, and a window rearrangement process of rearranging the one or the plurality of windows in order according to the Z-order managed by the management process when rearranging the one or the plurality of windows based on the position information for each window stored by the storage process.

### CROSS-REFERENCE TO RELATED APPLICATIONS

This application claims priority to Japanese Patent Application No. 2024-146852 filed on Aug. 28, 2024, the contents of which are hereby incorporated herein by reference in their entirety.

### BACKGROUND OF THE INVENTION

### Field of the Invention

The present invention relates to an information processing apparatus and a control method.

### Description of the Related Art

In recent years, an information processing apparatus in which a foldable flexible display (display unit) is provided over a first chassis and a second chassis to be bendable according to rotation between the first chassis and the second chassis is also disclosed (see, for example, Japanese Patent No. 7440672). In a case in which one display is provided across the first chassis and the second chassis in this manner, in addition to using the entire screen area of one display as one display area in a one-screen mode, it is also possible to use the screen area of one display split into two screen areas, one on the first chassis side and the other on the second chassis side, as a display area in a pseudo two-screen mode.

In addition, in a case in which one display is provided across the first chassis and the second chassis in this manner, it is common for the display to be configured as a touch panel without being equipped with a physical keyboard, but for example, Japanese Patent No. 7440672 discloses an example in which an external keyboard is placed on top of the screen area on the second chassis side and a half-screen mode is set in which the display is only on the screen area on the first chassis side, allowing the apparatus to be the same usage form as a laptop personal computer (PC) equipped with a physical keyboard.

### SUMMARY OF THE INVENTION

When the one-screen mode is switched to the half-screen mode, the screen area is halved, and thus the resolution of the display changes. An operating system (OS) rearranges windows of an application being displayed when the display resolution changes. For example, when the OS switches from the one-screen mode to the half-screen mode, the OS rearranges the positions of the windows that were displayed on the screen area of the display in the one-screen mode in half the screen area on the first chassis side. However, the OS rarely remembers the positions of the windows when in the one-screen mode. Therefore, even when switching to the half-screen mode and then back to the one-screen mode, the windows will remain arranged one-sidedly in half the screen area, and the only way to restore the windows at the original position thereof is to restore manually.

As a countermeasure, there is a method in which the positions of the windows in the one-screen mode are stored by a process separate from the OS process, and when switching from the half-screen mode to the one-screen mode, the windows are rearranged at the original position thereof in the one-screen mode, thereby making the OS recognize the positions of the windows in the one-screen mode. At this time, if the foremost window can be arranged first according to a Z-order, when other windows are arranged later, it is highly likely that the other windows will be hidden by the foremost window and less noticeable. However, because the OS does not provide the Z-order information of windows, when rearranging the windows at the original position thereof, the foremost window may not always be arranged first, and a plurality of windows may be seen to be rearranged in order. In particular, in a case in which there are a large number of windows, the sequential rearrangement of windows may be noticeable, and the appearance may be poor. Similarly, when swapping windows displayed in each screen area (for example, primary and secondary) in a two-screen mode, if the Z-order information of the windows is not known, then when rearranging windows from one screen area (for example, primary) to the other screen area (for example, secondary), if there are a large number of windows, the arrangement of the windows may be noticeable and the appearance may be poor.

As described above, when the layout of the display screen area is changed, the arrangement of windows could not be properly controlled.

The present invention has been made in view of the above circumstances, and embodiments of the present invention provide an information processing apparatus and a control method capable of properly controlling the arrangement of windows when a layout of a screen area of a display is changed.

Embodiments of the present invention have been made in order to solve the above-described problems, and an information processing apparatus according to the first aspect of the present invention includes a display, a memory configured to temporarily store a program of an application, and a processor configured to perform control of displaying windows of the application on the display by executing the program of the application stored in the memory, in which the processor is configured to perform a screen layout change process of changing a layout of an area in which one or a plurality of the windows are displayable, within a screen area of the display, a storage process of storing position information for each window before the layout of the screen area is changed by the screen layout change process, a management process of managing a Z-order of the one or the plurality of windows arranged in the screen area of the display, and a window rearrangement process of rearranging the one or the plurality of windows in order according to the Z-order managed by the management process, when rearranging the one or the plurality of windows based on the position information for each window stored by the storage process, after the layout of the screen area is changed by the screen layout change process.

In the information processing apparatus, in the screen layout change process, the processor may, in the screen layout change process, perform a change between a first layout in which an entire screen area of the display is used as the area in which the windows are displayable and a second layout in which a part of the screen area of the display is used as the area in which the windows are displayable, and when the layout is changed from the first layout to the second layout and back to the first layout by the screen layout change process, in the window rearrangement process, rearrange the windows based on the position information for each window stored by the storage process before changing the layout from the first layout to the second layout, and when rearranging the windows, rearrange the windows in order according to the Z-order immediately before changing the layout from the second layout back to the first layout by referring to the Z-order managed by the management process.

In the information processing apparatus, the processor may perform a placement detection process of detecting placement of an external keyboard on a predetermined area of the screen area of the display, and when the placement of the keyboard is detected by the placement detection process in the first layout, change the layout to the second layout in which the part of the screen area of the display, excluding the predetermined area, is the area in which the windows are displayable by the screen layout change process.

In the information processing apparatus, the processor may, when the layout is changed from the second layout back to the first layout by the screen layout change process, not execute the window rearrangement process on the windows that are minimized or maximized when changing the layout back to the first layout, and when the minimized or maximized windows are unminimized or unmaximized, execute the window rearrangement process to rearrange the unminimized or unmaximized windows.

In the information processing apparatus, the processor may, when the layout is changed from the second layout back to the first layout by the screen layout change process, not have to execute the window rearrangement process on the windows that are minimized or maximized when changing the layout from the first layout to the second layout, and when the minimized or maximized windows are unminimized or unmaximized, execute the window rearrangement process to rearrange the unminimized or unmaximized windows.

In the information processing apparatus, the processor may, in the screen layout change process, perform a layout change of swapping display of a first area and display of a second area in a layout in which the screen area of the display is split into a plurality of areas including the first area and the second area, and when the layout change of swapping the display of the first area and the display of the second area is performed by the screen layout change process, in the window rearrangement process, swap and rearrange a foremost first window out of the windows arranged in the first area and a foremost second window out of the windows arranged in the second area based on the position information for each window stored by the storage process before the layout change and the Z-order managed by the management process, and then rearrange the windows other than the first and second windows in order according to the Z-order managed by the management process.

In the information processing apparatus, the processor may, by the screen layout change process, perform a change between a first layout in which an entire screen area of the display is used as the area in which the windows are displayable and a third layout in which the screen area of the display is split into a plurality of areas including a first area and a second area, when changing the layout from the first layout to the third layout by the screen layout change process, in the window rearrangement process, minimize the windows other than a foremost window in each of the plurality of areas in the third layout, and when the layout is changed from the third layout back to the first layout by the screen layout change process, unminimize the windows that are minimized in the third layout, and rearrange the windows based on the position information for each window stored by the storage process before changing the layout from the first layout to the third layout and the Z-order managed by the management process.

In the information processing apparatus, the processor may, in the screen layout change process, perform a change between a first layout in which an entire screen area of the display is used as the area in which the windows are displayable and a third layout in which the screen area of the display is split into a plurality of areas, and when changing the layout from the third layout to the first layout by the screen layout change process, in the window rearrangement process, rearrange the one or the plurality of windows in order according to the Z-order managed by the management process.

In addition, a control method in an information processing apparatus according to the second aspect of the present invention including a display, a memory configured to temporarily store a program of an application, and a processor configured to perform control of displaying windows of the application on the display by executing the program of the application stored in the memory, the method including: via the processor, a screen layout change step of changing a layout of an area in which one or a plurality of the windows are displayable, within a screen area of the display; a storage step of storing position information for each window before the layout of the screen area is changed by the screen layout change step; a management step of managing a Z-order of the one or the plurality of windows arranged in the screen area of the display; and a window rearrangement step of rearranging the one or the plurality of windows in order according to the Z-order managed by the management step, when rearranging the one or the plurality of windows based on the position information for each window stored by the storage step, after the layout of the screen area is changed by the screen layout change step.

The above-described aspects of embodiments of the present invention can appropriately control the arrangement of windows when the layout of the screen area of a display is changed.

### BRIEF DESCRIPTION OF THE DRAWINGS

FIG. 1 is a perspective view illustrating an appearance of an information processing apparatus according to a first embodiment.

FIG. 2 is a side view illustrating an example of the information processing apparatus in a bent form according to the first embodiment.

FIG. 3 is a side view illustrating an example of the information processing apparatus in a flat form according to the first embodiment.

FIG. 4 is a view illustrating specific examples of various display modes of the information processing apparatus according to the first embodiment.

FIGS. 5(A)-(C) are views illustrating an example of an operation specification of a display mode switching operation according to the first embodiment.

FIG. 6 is a view illustrating an example of rearrangement of windows following a change in a screen layout according to the first embodiment.

FIGS. 7(A)-(D) are views illustrating an example of a list of window information according to the first embodiment.

FIG. 8 is a block view illustrating a hardware configuration example of the information processing apparatus according to the first embodiment.

FIG. 9 is a block view illustrating an example of a functional configuration of a control unit according to the first embodiment.

FIG. 10 is a flowchart illustrating an example of a window rearrangement process following a change in the screen layout according to the first embodiment.

FIG. 11 is a flowchart illustrating a detailed example of the window rearrangement process following a change in the screen layout according to the first embodiment.

FIG. 12 is a view illustrating another example of the rearrangement of windows following a change in the screen layout according to the first embodiment.

FIG. 13 is a flowchart illustrating an example of a process when there is a minimized window in the window rearrangement process following a change in the screen layout according to the first embodiment.

FIG. 14 is a flowchart illustrating a detailed example of a process when there is a minimized window in the window rearrangement process following a change in the screen layout according to the first embodiment.

FIG. 15 is a view illustrating an example of the rearrangement of windows following a change in a screen layout according to a second embodiment.

FIG. 16 is a flowchart illustrating an example of a window rearrangement process following a change in the screen layout according to the second embodiment.

FIG. 17 is a flowchart illustrating a detailed example of the window rearrangement process following a change in the screen layout according to the second embodiment.

FIG. 18 is a flowchart illustrating an example of the rearrangement process when a plurality of minimized windows are simultaneously unminimized, according to the second embodiment.

FIG. 19 is a view illustrating an example of a change in the screen layout according to a third embodiment.

FIG. 20 is a flowchart illustrating an example of a window rearrangement process following a change in a screen layout according to the third embodiment.

FIG. 21 is a view illustrating an example of a change in the screen layout according to a fourth embodiment.

FIG. 22 is a flowchart illustrating an example of a window rearrangement process following a change in a screen layout according to the fourth embodiment.

### DETAILED DESCRIPTION OF THE INVENTION

Hereinafter, embodiments of the present invention will be described with reference to the accompanying drawings.

### First Embodiment

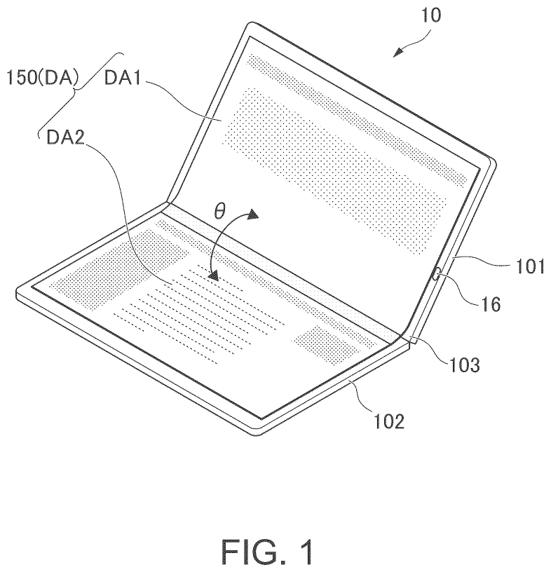

FIG. 1 is a perspective view illustrating the appearance of an information processing apparatus 10 according to the present embodiment. The information processing apparatus 10 according to the present embodiment is a clamshell (laptop) personal computer (PC). The information processing apparatus 10 is provided with a first chassis 101, a second chassis 102, and a hinge mechanism 103. The first chassis 101 and the second chassis 102 are chassis having a substantially quadrangular plate shape (for example, flat plate shape). One of side surfaces of the first chassis 101 and one of side surfaces of the second chassis 102 are coupled (connected) via the hinge mechanism 103, and the first chassis 101 and the second chassis 102 are relatively rotatable around a rotation axis formed by the hinge mechanism 103. A state in which an opening angle θ around the rotation axis of the first chassis 101 and the second chassis 102 is about 0° is a state in which the first chassis 101 and the second chassis 102 overlap with each other and are closed. A state in which the first chassis 101 and the second chassis 102 are closed will be referred to as a “closed state”. In the closed state, surfaces of the first chassis 101 and the second chassis 102 facing each other will be referred to as the respective “inner surfaces”, and surfaces opposite to the inner surfaces will be referred to as “outer surfaces”. The opening angle θ can also be referred to as an angle formed by the inner surface of the first chassis 101 and the inner surface of the second chassis 102. A state in which the first chassis 101 and the second chassis 102 are opened with respect to the closed state will be referred to as an “open state”. The open state is a state in which the first chassis 101 and the second chassis 102 are relatively rotated until the opening angle θ exceeds a preset threshold value (for example,) 10°.

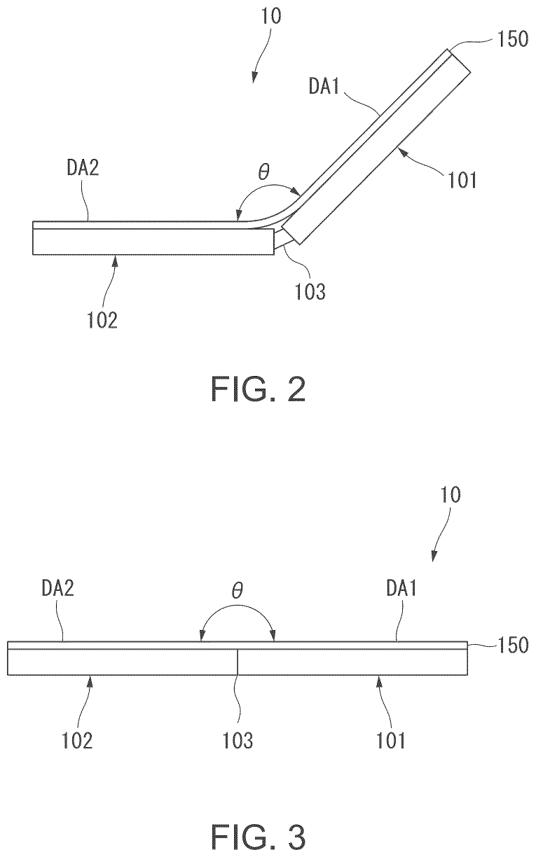

The information processing apparatus 10 is provided with a camera 16 and a display 150. The camera 16 is provided on the inner surface of the first chassis 101. The display 150 is provided over the inner surface of the first chassis 101 and the inner surface of the second chassis 102. The camera 16 is provided in, for example, an outer portion of a screen area DA of the display 150 on the inner surface of the first chassis 101, and can image a user or the like who exists on the side facing the display 150. The display 150 is a flexible display that can be bent according to the opening angle θ due to the relative rotation of the first chassis 101 and the second chassis 102 (see FIGS. 2 and 3). An organic EL display or the like is used as the flexible display. The information processing apparatus 10 can control display of the entire screen area DA of the display 150 as one display area in a one-screen configuration, and can also control display by splitting the screen area DA of the display 150 into two display areas, a first screen area DA1 and a second screen area DA2, in a two-screen configuration. Since the two display areas that split into the first screen area DA1 and the second screen area DA2 split the screen area DA, the display areas do not overlap each other. Here, out of the screen areas DA of the display 150, a screen area corresponding to the inner surface side of the first chassis 101 is defined as the first screen area DA1, and a screen area corresponding to the inner surface side of the second chassis 102 is defined as the second screen area DA2. In the following description, a display mode in which display is controlled with the one-screen configuration will be referred to as a “one-screen mode”, and a display mode in which display is controlled with the two-screen configuration will be referred to as a “two-screen mode”.

A touch sensor is provided on the screen area DA (the surface) of the display 150. The information processing apparatus 10 can detect a touch operation on the screen area DA of the display 150. By bringing the information processing apparatus 10 into an open state, the user can visually recognize display of the display 150 provided on the inner surface of each of the first chassis 101 and the second chassis 102, or can perform the touch operation on the display 150, and thus can use the information processing apparatus 10.

Hereinafter, a usage form and the screen mode of the information processing apparatus 10 will be described in detail. First, the usage forms of the information processing apparatus 10 are classified into a bent form in which the first chassis 101 and the second chassis 102 are bent according to the opening angle θ between the first chassis 101 and the second chassis 102, and a flat form in which the first chassis 101 and the second chassis 102 are not bent. In the following description, the bent form in which the first chassis 101 and the second chassis 102 are bent will be simply referred to as a “bent form”, and the flat form in which the first chassis 101 and the second chassis 102 are not bent will be simply referred to as a “flat form”. In the bent form, the display 150 provided over the first chassis 101 and the second chassis 102 is also in the bent form. In the flat form, the display 150 is also in the flat form.

FIG. 2 is a side view illustrating an example of the information processing apparatus 10 in the bent form. The display 150 is arranged over (across) the first chassis 101 and the second chassis 102. The screen area of the display 150 (the screen area DA illustrated in FIG. 1) can be folded (bent) with a portion corresponding to the hinge mechanism 103 as a crease, and the screen area on the first chassis 101 side is illustrated as the first screen area DA1 and the screen area on the second chassis 102 side is illustrated as the second screen area DA2 with the crease as a boundary. The display 150 is bent according to rotation (opening angle θ) between the first chassis 101 and the second chassis 102. It is determined whether or not the information processing apparatus 10 is in the bent form according to the opening angle θ. As an example, in a case in which 10°<θ<170°, it is determined that the information processing apparatus 10 is in the bent form. This state corresponds to the usage form such as a so-called clamshell mode or book mode.

FIG. 3 is a side view illustrating an example of the information processing apparatus 10 in a flat form. It is typically determined that the information processing apparatus 10 is in the flat form in a case in which the opening angle θ is 180°, but as an example, it may be determined that the information processing apparatus 10 is in the flat form in a case in which 170° ≥θ<180°. For example, in a case in which the opening angle θ between the first chassis 101 and the second chassis 102 is 180°, the display 150 is also in the flat form. This state corresponds to the usage form called a so-called tablet mode.

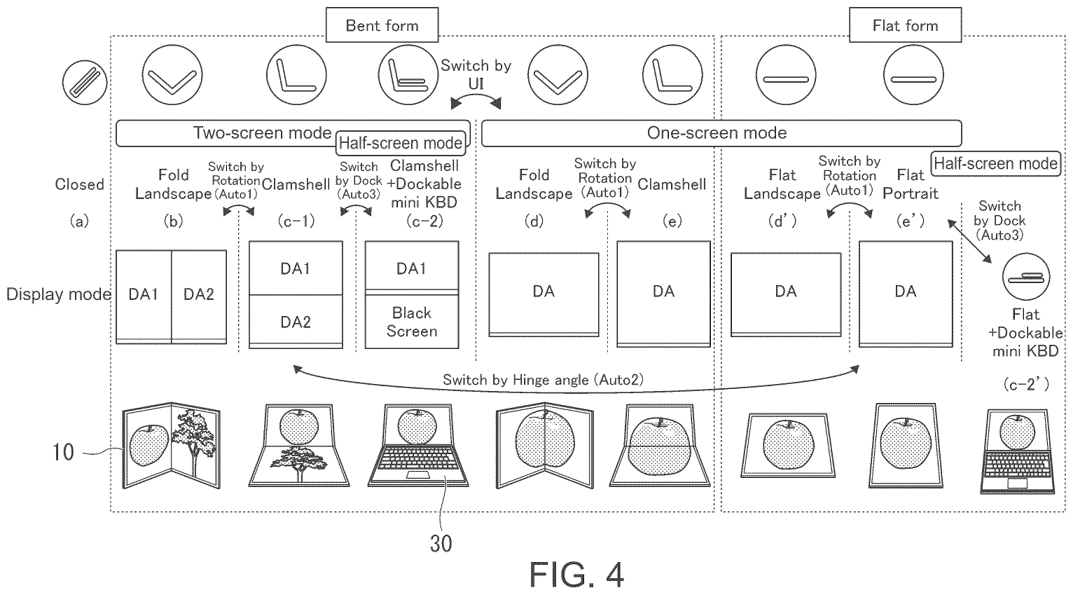

Hereinafter, with reference to FIG. 4, the display modes according to various usage forms of the information processing apparatus 10 will be described in detail.

FIG. 4 is a view illustrating specific examples of various display modes of the information processing apparatus 10 according to the present embodiment. The information processing apparatus 10 has different display modes according to the usage forms classified according to the opening angle θ between the first chassis 101 and the second chassis 102, a posture (orientation) of the information processing apparatus 10, whether the one-screen mode is used or the two-screen mode is used, and the like. The one-screen will also be called a single screen, and the two-screen will also be called a split screen, a dual screen, or the like.

A display mode (a) is a display mode when the first chassis 101 and the second chassis 102 are in the closed state (Closed) as the usage form. In this closed state, the information processing apparatus 10 is, for example, in a standby state such as a sleep or suspended state (hibernation), and the display 150 is in a display-off state. The standby state such as the sleep or suspended state (hibernation) corresponds to S3 or S4 of a power supply state of a system defined by, for example, an advanced configuration and power interface (ACPI).

A display mode (b) is a display mode when the usage form is the bent form, and the two-screen mode is used in which display is controlled such that the screen area DA of the display 150 is split into the two display areas, the first screen area DAL and the second screen area DA2. The orientation of the information processing apparatus 10 is an orientation in which the first screen area DA1 and the second screen area DA2 are in a portrait orientation and are horizontally arranged from side to side. The portrait orientation of the screen area is an orientation in which a long side of four sides of a rectangular screen area DA is in a vertical direction and a short side is in a horizontal direction. In a case in which the screen area is in the portrait orientation, a display orientation is also the portrait orientation, and display is performed in an orientation in which a direction along the long side corresponds to an up-down direction and a direction along the short side corresponds to a left-right direction. This usage form is a usage form in which left and right pages when a book is opened correspond to left and right screens, and corresponds to the so-called book mode. This usage form is also called “Fold Landscape” because the first screen area DA1 and the second screen area DA2 are in a bent form and the combined display area of the two is horizontally long.

In this display mode (b), for example, in a normal operation state, the information processing apparatus 10 is in the two-screen display mode in which the first screen area DA1 on the left side is used as a primary screen and the second screen area DA2 on the right side is used as a secondary screen. It should be noted that, in the display mode (b), a correspondence relationship between the first screen area DA1 and the second screen area DA2, and the primary screen and the secondary screen may be reversed.

As in the display mode (b), a display mode (c-1) is a display mode when the usage form is the bent form, and the two-screen mode is used in which display is controlled by splitting the screen area DA of the display 150 into two display areas, the first screen area DA1 and the second screen area DA2, but an orientation of the information processing apparatus 10 is different. The orientation of the information processing apparatus 10 is an orientation in which the first screen area DA1 and the second screen area DA2 are in a landscape orientation and are vertically arranged up and down. The landscape orientation of the screen area is an orientation in which a long side of four sides of a rectangular screen area DA is in a horizontal direction and a short side is in a vertical direction. In a case in which the screen area is in the landscape orientation, a display orientation is also the landscape orientation, and display is performed in an orientation in which a direction along the short side corresponds to an up-down direction and a direction along the long side corresponds to a left-right direction. This usage form is one of general usage forms of a clamshell PC.

In this display mode (c-1), for example, in a normal operation state, the information processing apparatus 10 is in the two-screen display mode in which the first screen area DA1 is used as a primary screen and the second screen area DA2 is used as a secondary screen. It should be noted that, in the display mode (c-1), a correspondence relationship between the first screen area DA1 and the second screen area DA2, and the primary screen and the secondary screen may be reversed.

For example, the information processing apparatus 10 detects a change in the posture (orientation) of the information processing apparatus 10, and thus automatically performs switching from the display mode (b) to the display mode (c-1) or from the display mode (c-1) to the display mode (b) (Switch by Rotation). For example, since the display mode (c-1) is a state in which the display 150 is rotated 90 degrees rightward with respect to the display mode (b) as illustrated, when the rightward rotation from a state of the display mode (b) by a predetermined angle (for example, 45 degrees) or more is detected, the information processing apparatus 10 performs the switching to the display mode (c-1). Since the display mode (b) is a state in which the display 150 is rotated 90 degrees leftward with respect to the display mode (c-1) as illustrated, when the leftward rotation from a state of the display mode (c-1) by a predetermined angle (for example, 45 degrees) or more is detected, the information processing apparatus 10 performs the switching to the display mode (b).

As in the display mode (c-1), in a display mode (c-2), the bent form is used and the orientation of the information processing apparatus 10 is the same, but there is a difference in that an external keyboard 30 (Dockable mini Keyboard (KBD)) that can be connected to the information processing apparatus 10 is connected. This usage form is a state in which the physical keyboard 30 is connected in a general usage form of a clamshell PC. For example, the keyboard 30 has almost the same size as that of the second screen area DA2 and is configured to be able to be placed on the second screen area DA2. As an example, the keyboard 30 is provided with a magnet inside (end portion) of a bottom surface thereof, and when placed on the second screen area DA2, the keyboard 30 is attracted and fixed to a metal portion of the inner surface end portion of the second chassis 102. As a result, the usage form is the same as the usage form of a conventional clamshell PC that is originally provided with the physical keyboard. In addition, if the keyboard 30 is placed on the second screen area DA2, the placed keyboard 30 and the information processing apparatus 10 are communicatively connected to each other by, for example, Bluetooth (registered trademark). In this display mode (c-2), the information processing apparatus 10 controls the second screen area DA2 to be displayed black or turned off because the second screen area DA2 cannot be visually recognized due to the keyboard. That is, this display mode (c-2) is a display mode in which only half of the screen area DA is enabled to be displayed (hereinafter, referred to as “half-screen mode”) and corresponds to the one-screen mode in which only the first screen area DA1 is targeted for display.

For example, when the information processing apparatus 10 detects a connection with an external keyboard in the state of the display mode (c-1), the information processing apparatus 10 automatically switches from the display mode (c-1) to the display mode (c-2) (Switch by Dock).

As in the display mode (b), in a display mode (d), the bent form is used and the orientation of the information processing apparatus 10 is the same, but there is a difference in that the display mode (d) is the one-screen mode in which display is controlled such that the entire screen area DA of the display 150 is used as one display area. This usage form is different from the display mode (b) in that the one-screen mode is used, but will also be referred to as the “Fold Landscape” because the bent form is used and the screen area DA is horizontally long. The screen area DA is in the landscape orientation, and the display orientation is also the landscape orientation.

Here, the switching between the one-screen mode and the two-screen mode in the bent form is performed, for example, by the user's operation. For example, the information processing apparatus 10 displays an operating element as a UI (User Interface) that can switch between the one-screen mode and the two-screen mode at any place on the screen, and switches from the display mode (b) to the display mode (d) based on the operation on the operating element (Switch by UI). Specific examples of this display mode switching operation will be described below.

As in the display mode (c-1), in a display mode (e), the bent form is used and the orientation of the information processing apparatus 10 is the same, but there is a difference in that the display mode (e) is the one-screen mode in which display is controlled such that the entire screen area DA of the display 150 is used as one display area. This usage form is different from the display mode (c-1) in that the one-screen mode is used, but corresponds to the usage form of the clamshell PC in terms of the bent form and the orientation of the information processing apparatus 10. The screen area DA is in the portrait orientation, and the display orientation is also the portrait orientation.

For example, the information processing apparatus 10 detects a change in the posture (orientation) of the information processing apparatus 10, and thus automatically performs switching from the display mode (d) to the display mode (e) or from the display mode (e) to the display mode (d) (Switch by Rotation). For example, since the display mode (e) is a state in which the display 150 is rotated 90 degrees rightward with respect to the display mode (d) as illustrated, when the rightward rotation from a state of the display mode (d) by a predetermined angle (for example, 45 degrees) or more is detected, the information processing apparatus 10 performs the switching to the display mode (e). Since the display mode (d) is a state in which the display 150 is rotated 90 degrees leftward with respect to the display mode (e) as illustrated, when the leftward rotation from a state of the display mode (e) by a predetermined angle (for example, 45 degrees) or more is detected, the information processing apparatus 10 performs the switching to the display mode (d).

Similar to the display mode (d), the display mode (d′) is a one-screen mode, and is a mode in which an orientation of the information processing apparatus 10 is also an orientation in which the screen area DA is horizontally long, but is different therefrom in that a flat form is used. The flat form is a state in which the opening angle θ between the first chassis 101 and the second chassis 102 is about 180°. This usage form corresponds to the so-called tablet mode described with reference to FIG. 3, and will also be referred to as “flat landscape” because a flat form is used and the screen area DA is horizontally long. This display mode (d′) is different from the display mode (d) only in terms of the opening angle θ between the first chassis 101 and the second chassis 102. As in the display mode (d), the screen area DA is in the landscape orientation, and the display orientation is also the landscape orientation.

As in the display mode (e), in a display mode (e′), the one-screen mode is used and the orientation of the information processing apparatus 10 is also an orientation in which the screen area DA is vertically long, but there is a difference in that the flat form is used. This usage form will also be referred to as a “Flat Portrait” because the flat form is used and the screen area DA is vertically long. This display mode (e′) is different from the display mode (e) only in terms of the opening angle θ between the first chassis 101 and the second chassis 102. As in the display mode (e), the screen area DA is in the portrait orientation, and the display orientation is also the portrait orientation.

For example, the information processing apparatus 10 detects a change in the posture (orientation) of the information processing apparatus 10, and thus automatically performs switching from the display mode (d′) to the display mode (e′) or from the display mode (e′) to the display mode (d′) (Switch by Rotation). For example, since the display mode (e′) is a state in which the display 150 is rotated 90 degrees rightward with respect to the display mode (d′) as illustrated, when the rightward rotation from a state of the display mode (d′) by a predetermined angle (for example, 45 degrees) or more is detected, the information processing apparatus 10 performs the switching to the display mode (e′). Since the display mode (d′) is a state in which the display 150 is rotated 90 degrees leftward with respect to the display mode (e′) as illustrated, when the leftward rotation from a state of the display mode (e′) by a predetermined angle (for example, 45 degrees) or more is detected, the information processing apparatus 10 performs the switching to the display mode (d′).

In the display mode (d′) and the display mode (e′), the user can operate the display mode switching icon described above to switch to the two-screen mode while maintaining a flat form. For example, when the switching from a state of the display mode (d′) to the two-screen mode is performed, the display state is the same as the display state of the display mode (b) in the flat form. When the switching from a state of the display mode (e′) to the two-screen mode is performed, the display state is the same as the display state of the display mode (c-1) in the flat form.

When the information processing apparatus 10 detects the connection with the keyboard 30 in a state of the display mode (e′), the information processing apparatus 10 automatically performs the switching from the display mode (e′) to the display mode (c-2′) (Switch by Dock). The display mode (c-2′) is the flat form, and is different from the display mode (c-2) only in terms of the opening angle θ between the first chassis 101 and the second chassis 102. In this display mode (c-2′), the information processing apparatus 10 controls the second screen area DA2 to be displayed black or turned off because the second screen area DA2 cannot be visually recognized due to the keyboard. That is, the display mode (c-2′) is a half-screen mode in which only the first screen area DA1 is targeted for display, similarly to the display mode (c-2).

In addition, the information processing apparatus 10 can be configured to perform the switching from the one-screen mode to the two-screen mode in a case in which the change from the flat form to the bent form is detected. For example, in a case in which the change to the bent form in a state of the display mode (d′) is detected based on the opening angle θ between the first chassis 101 and the second chassis 102, the information processing apparatus 10 automatically performs the switching from the display mode (d′) to the display mode (b). In addition, in a case in which the change to the bent form in a state of the display mode (e′) is detected based on the opening angle θ between the first chassis 101 and the second chassis 102, the information processing apparatus 10 automatically performs the switching from the display mode (e′) to the display mode (c-1).

### (Display Mode Switching Operation)

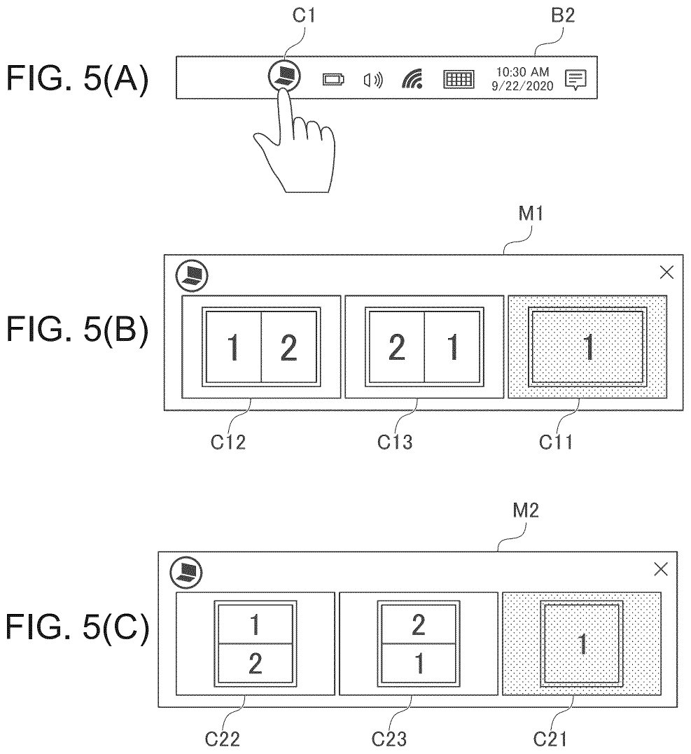

Hereinafter, a specific example of an operation specification when the display modes are switched by the user's operation will be described. FIG. 5 is a view illustrating an example of the operation specification of the display mode switching operation according to the present embodiment. For example, as illustrated in FIG. 5(A), an icon C1 for displaying a switching menu of the display mode is displayed on a task bar B2. The task bar B2 is displayed on any of the screen areas DA of the display 150. For example, the task bar B2 is displayed only at one location (for example, the bottommost part of the screen area DA) in the screen area DA of the display 150 regardless of whether the one-screen mode is used or the two-screen mode is used. It should be noted that, in a case of the two-screen mode, the task bar B2 may be displayed in each of the first screen area DA1 and the second screen area DA2 (for example, in each bottommost part).

When the operation is performed on the icon C1 for displaying the switching menu, the switching menu of the display mode is displayed as a pop-up screen. The switching menu of the display mode may be displayed as a pop-up screen when the display mode changes from a bent form to a flat form. In addition, the switching menu of the display mode may be displayed as the pop-up screen when the flat form is changed to the bent form.

In the switching menu, a display mode switching icon for the user to give an instruction to switch between the one-screen mode and the two-screen mode and to swap (for example, swap between the primary screen and the secondary screen) the display data to be displayed in each of the first screen area DA1 and the second screen area DA2 in the two-screen mode is displayed as an option of the display mode. In the switching menu, the options of the display mode selectable by the user are displayed according to the usage form (orientation of the display 150) in this case.

FIG. 5(B) illustrates a switching menu M1 displayed when the usage form is the “Landscape” (display mode (b), display mode (d), display mode (d′), or the like). The “1” and “2” in the figure are attached to distinguish the display area in the two-screen mode and will be referred to as display area “1” and display area “2” in the following. A display mode switching icon C11, a display mode switching icon C12, and a display mode switching icon C13 are displayed on the switching menu M1. The display mode switching icon C11 is displayed as an operating element for selecting the display mode (d) or the display mode (d′) in the one-screen mode. The display mode switching icon C12 and the display mode switching icon C13 are displayed as operating elements for selecting the display mode (b) of the two-screen mode, and the arrangement of the display area “1” and the display area “2” is different between the display mode switching icon C12 and the display mode switching icon C13. Here, when the case in which the display area “1” and the display area “2” of the display mode switching icon C12 are arranged is considered to be a two-screen mode, the case in which the display area “1” and the display area “2” of the display mode switching icon C13 are arranged is considered to be an inverted two-screen mode.

The display mode switching icon corresponding to the current display mode is displayed in a display mode that is distinguishable from other display mode switching icons. Here, the display mode switching icons C12 and C13 are highlighted so that it can be seen that the display mode switching icon C11 is the current display mode.

FIG. 5(C) illustrates a switching menu M2 displayed when the usage form is “Clamshell” (display mode (c-1), display mode (e), display mode (e′), and the like). A display mode switching icon C21, a display mode switching icon C22, and a display mode switching icon C23 are displayed on the switching menu M2. The display mode switching icon C21 is displayed as an operating element for selecting the display mode (e) or the display mode (e′) in the one-screen mode. The display mode switching icon C22 and the display mode switching icon C23 are displayed as operating elements for selecting the display mode (c-1) of the two-screen mode, and the arrangement of the display area “1” and the display area “2” is different between the display mode switching icon C22 and the display mode switching icon C23. Here, when the case in which the display area “1” and the display area “2” of the display mode switching icon C22 are arranged is considered to be the two-screen mode, the case in which the display area “1” and the display area “2” of the display mode switching icon C23 are arranged is considered to be an inverted two-screen mode.

Similar to the switching menu M1 illustrated in FIG. 5(B), the display mode switching icon corresponding to the current display mode is displayed in a display mode that is distinguishable from other display mode switching icons. Here, the display mode switching icons C22 and C23 are highlighted so that it can be seen that the display mode switching icon C21 is the current display mode.

The user can optionally select any of the display mode switching icons displayed on the switching menu M1 or the switching menu M2. When the user selects any of the display mode switching icons, display of the switching menu is terminated. Alternatively, in a case in which the user does not select any display mode switching icon within a predetermined time (for example, 3 to 5 seconds) after the switching menu M1 or the switching menu M2 is displayed, display of the switching menu is terminated. In addition, in a case in which the user operates a close button “x” on the upper right of the switching menu, in a case in which the user operates an outside of the screen of the popped up switching menu, or in a case in which the orientation of the information processing apparatus 10 is changed, display of the switching menu is terminated. In a state in which the keyboard 30 is connected, the half-screen mode (display mode (c-2)) in which only the first screen area DA1 is targeted for display is fixed, and thus the switching menu is not displayed.

It should be noted that the UI for switching between the one-screen mode and the two-screen mode is not limited to the example illustrated in FIG. 5, and any UI can be used. For example, an icon for alternately switching between the one-screen mode and the two-screen mode each time an operation is performed, or an icon for switching between the one-screen mode, the two-screen mode, and the inverted two-screen mode in turn each time the operation is performed may be displayed on the task bar B2.

In addition, in the example illustrated in FIG. 5, the switching menu of the display mode is displayed as a pop-up screen by an operation on the icon C1 displayed on the task bar B2, but the switching menu may be displayed as a pop-up screen by a drag operation or the like on a window of an application. In addition, the display mode may be switched by a drag operation or the like on the window of the application. In a case in which the switching menu is popped up by a drag operation on the window of the application, the application being dragged may be arranged in the selected area by allowing not only the screen mode but also the selection of the screen area by dragging over one of the split areas of the screen area displayed in the switching menu. In addition, the switching menu may be displayed as a pop-up screen by an operation on a specific place of the window of the application.

As described above, when performing control of displaying a window of an application in the screen area of the display 150, the information processing apparatus 10 can change a layout of a window-displayable screen area (hereinafter, referred to as a “screen layout”) such as a one-screen mode, a two-screen mode, an inverted two-screen mode, and a half-screen mode. In the following description, the window of the application is also simply referred to as a “window”.

The information processing apparatus 10 can store the position information of each window before the screen layout is changed, and can also rearrange the window at the position and size before the change at any timing after the screen layout is changed. Hereinafter, the control of the rearrangement of windows following a change in the screen layout will be described in detail.

### (Control of Rearrangement of Windows Following Change in Screen Layout)

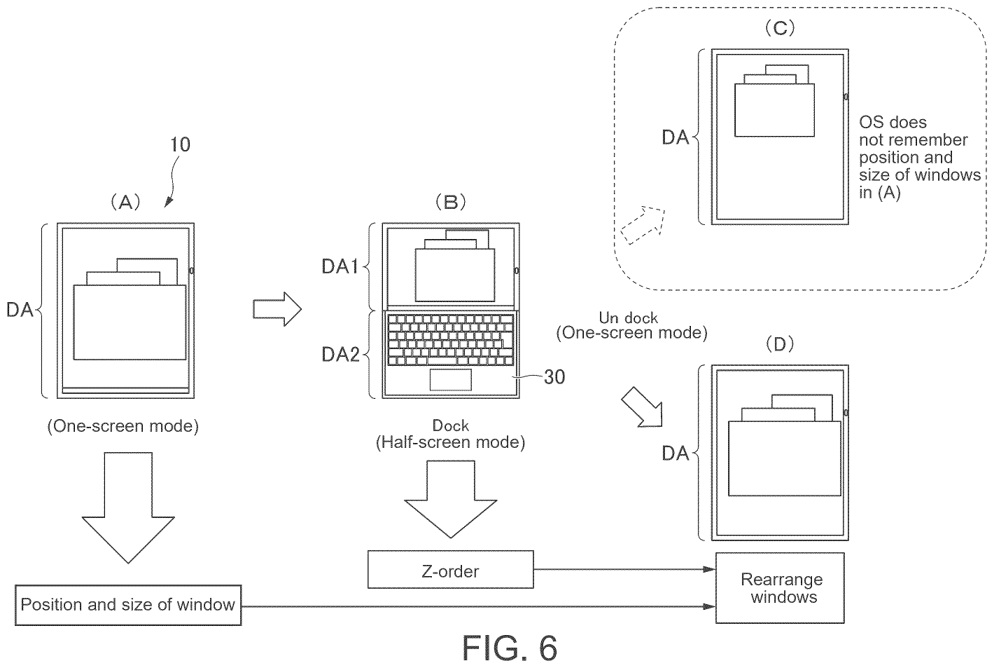

FIG. 6 is a view illustrating an example of the rearrangement of windows following a change in the screen layout according to the present embodiment. With reference to FIG. 6, an example will be described, in which when switching from the one-screen mode to the half-screen mode and then back to the one-screen mode again, the information processing apparatus 10 rearranges the window at the position and size of the window before switching to the half-screen mode.

As illustrated in view (A) of FIG. 6, the information processing apparatus 10 controls the screen layout in which the entire screen area DA of the display 150 is targeted for display in the one-screen mode. Here, a plurality of windows are arranged in the screen area DA.

As illustrated in view (B) of FIG. 6, when the connection (docking) to the keyboard 30 is detected, the information processing apparatus 10 switches to half-screen mode, controls the second screen area DA2 to be displayed black or turned off, and changes to a screen layout in which only the first screen area DA1 is targeted for display. Since the screen area which is targeted for display is only half of the first screen area DA1 from the entire screen area DA, the resolution changes. The operating system (OS) of the information processing apparatus 10 rearranges the plurality of windows arranged in the screen area DA in one-screen mode to the first screen area DA by changing the position and size thereof according to the change in resolution.

Next, an example of the rearrangement of windows when the keyboard 30 is disconnected (undocked) will be described. In a case in which the control is performed by the OS, since the OS does not remember the positions and sizes of the windows in the one-screen mode before switching to the half-screen mode, the windows remain arranged in the upper half the screen area DA (the area corresponding to the first screen area DA1) after switching back to the one-screen mode, as illustrated in view (C) of FIG. 6. The windows will remain arranged one-sidedly in half the screen area, and the only way to restore the windows to the original position thereof is to restore the windows manually.

Therefore, in the present embodiment, the information processing apparatus 10 stores the position and size of each window in the one-screen mode illustrated in view (A) of FIG. 6 (that is, before switching to the half-screen mode) in a process separate from the OS process, and when switching from the half-screen mode back to the one-screen mode, the information processing apparatus 10 rearranges each window at the original position and size that are stored, as illustrated in view (D) of FIG. 6. The timing at which the position and size information for each window is stored is, for example, when the application is run or when the position or size of a window is changed, and the position and size information is updated to the latest information at any time.

In addition, in a case in which the plurality of windows are rearranged without following the Z-order of the windows at this time, the appearance of the plurality of windows being arranged in turn (a phenomenon called flashing, for example) will be visible and will not look good. Here, in a case in which there are a plurality of windows to be displayed on the display 150, the Z-order is the priority order in which each window is displayed in front of other windows when displayed in an overlapped manner. For example, a first window in the Z-order is a window having the highest priority and is displayed in the foremost side.

Even after switching to the half-screen mode, the Z-order changes according to the user's operation, and thus the latest Z-order information is needed when rearranging the window, but is not provided from the OS. Therefore, in the present embodiment, the information processing apparatus 10 also manages the Z-order after switching to the half-screen mode in a process separate from the OS process. In a case in which the information processing apparatus 10 performs the management of the Z-order by a process separate from the OS process, the information processing apparatus 10 may perform the management of the Z-order not only after switching to the half-screen mode, but also at any time before switching to the half-screen mode. For example, the information processing apparatus 10 stores and updates the Z-order at a timing when there is a change in the Z-order, such as when a window is selected and becomes an active window.

That is, the information processing apparatus 10 in the present embodiment stores the position and size information for each window in a separate process from the OS process in the one-screen mode illustrated in view (A) of FIG. 6 (that is, before switching to the half-screen mode), and also manages and stores the Z-order after switching to the half-screen mode illustrated in view (B) of FIG. 6 by connecting with the keyboard 30 (docking) in a process separate from the OS process. In a case in which the keyboard 30 is disconnected (undocked), the information processing apparatus 10 switches from the half-screen mode back to the one-screen mode, and when rearranging the window based on the position and size information for each window stored in the one-screen mode illustrated in view (A) of FIG. 6, the information processing apparatus 10 rearranges the window in order according to the Z-order (the latest Z-order) that is managed in the half-screen mode illustrated in view (B) of FIG. 6.

As a result, the information processing apparatus 10 can arrange the foremost window first according to the Z-order, and then arrange the other windows in turn on the rear side of the arranged window, and thus it is highly likely that the other windows will be hidden by the foremost window when the other windows are arranged later, making the windows less noticeable.

Here, an example of a method of managing and retaining the Z-order separately from the OS by the information processing apparatus 10 will be described. First, a one-dimensional table is prepared, which stores elements consisting of an ID indicating the window of the currently launched application or may be a pointer to the instance) and a pair of position and size of the window in the one-screen mode as window information. Although a simple one-dimensional array may be used for this table, it is preferable to use a data structure such as a concatenated list or a container type because of the need to delete or swap the order of elements relatively frequently in the process described below. Hereinafter, this table will be referred to as a list.

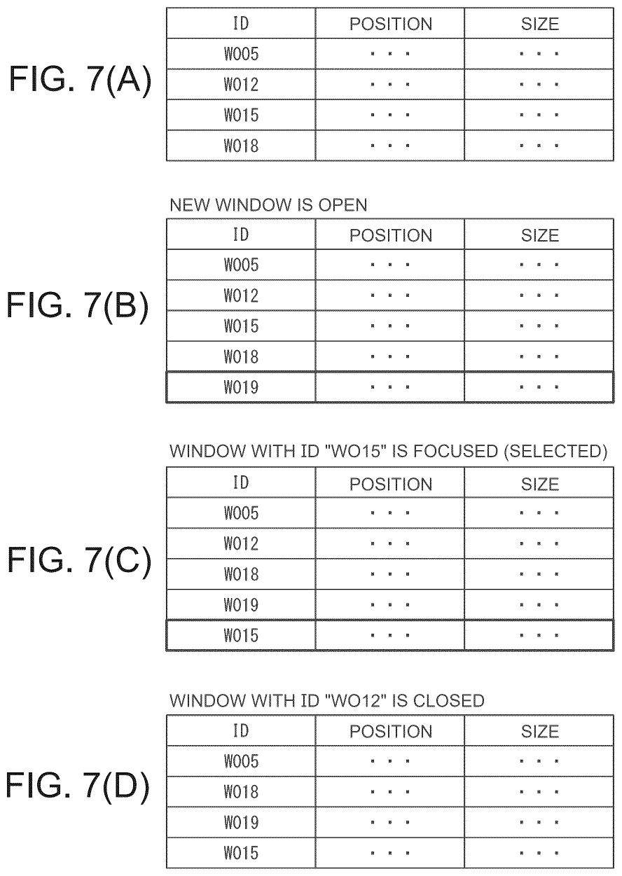

FIG. 7 is a view illustrating an example of a list of window information according to the present embodiment. In the list of window information illustrated in this figure, the ID, the position, and the size of a window are stored in association with each other. The list illustrated in FIG. 7(A) is an example when four windows are opened, and the ID, the position, and the size of each of the four windows are stored in association with each other. The window of the ID “W018” at the end of the list is a window displayed in the foremost side, and the window information is stored in the order of Z-order from the end to the head of the list.

The information processing apparatus 10 acquires all events when a new window is opened and displayed from the time of OS startup, and adds the window information (ID, position and size information) to the end of the list each time one window is opened. The list illustrated in FIG. 7(B) is an example of a list when a new window is opened with respect to FIG. 7(A), and window information is added to the end of the list with the ID “W019” and position and size information associated with the new window.

In addition, when an already open window is focused (selected) by the user's operation, the window is displayed in the foremost side under the control of the OS. In this case, the information processing apparatus 10 acquires this focus event, searches for the ID of the window in the list, and moves the information of the window with the ID to the end of the list (deletes and re-adds the information of the window to the end of the list). FIG. 7(C) illustrates an example of a list when the window with the ID “W015” is focused (selected) with respect to FIG. 7(B), and the window information for the ID “W015” is moved to the end of the list.

In a case in which the position or size of a window is changed in the one-screen mode, the information processing apparatus 10 updates the position and size information retained in the list paired with the ID of the changed window, but does not update the position and size information in the half-screen mode. However, since the Z-order changes when a window is focused (selected) even in the half-screen mode, the information processing apparatus 10 moves the window information to the end of the list without updating the position and size.

The information processing apparatus 10 also acquires an event in a case in which a window is closed and deletes the information of the window from the list. FIG. 7(D) illustrates an example of a list when a window with the ID “W012” is closed with respect to FIG. 7(C), and the window information of the ID “W012” is deleted from the list.

In this way, the list is always maintained with the information of the corresponding window (ID, position and size information) in order from the oldest window displayed (focused) to the newest. In other words, if the list is read later, the list accurately represents the arrangement of the windows displayed in order from the front, that is, the current Z-order. Thus, when switching from the half screen back to the full screen, the information processing apparatus 10 resizes and rearranges the windows in order from the end of the list, while retaining the Z-order. Therefore, since the windows are rearranged in order starting with the foremost window, the resizing and rearrangement of later windows is less visible to the user, and the user is less likely to feel the display flickering.

### (Hardware Configuration of Information Processing Apparatus 10)

Hereinafter, a specific configuration of the information processing apparatus 10 will be described.

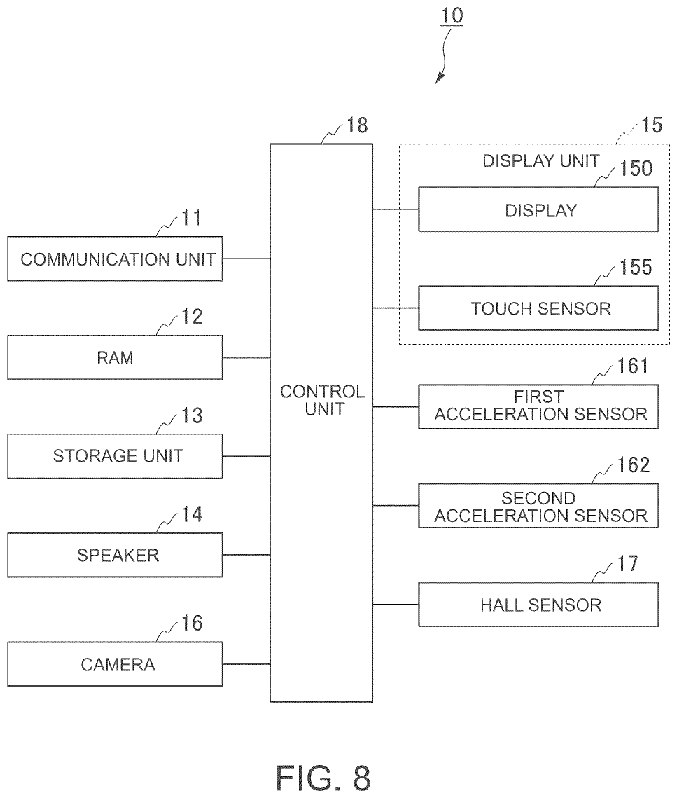

FIG. 8 is a block view illustrating an example of a hardware configuration of the information processing apparatus 10 according to the present embodiment. The information processing apparatus 10 is provided with a communication unit 11, a random access memory (RAM) 12, a storage unit 13, a speaker 14, a display unit 15, the camera 16, a first acceleration sensor 161, a second acceleration sensor 162, a hall sensor 17, and a control unit 18. These units are communicably connected to each other via a bus or the like.

The communication unit 11 includes, for example, digital input/output ports such as a plurality of Ethernet (registered trademark) ports or a plurality of universal serial buses (USB), and a communication device that performs wireless communication such as Bluetooth (registered trademark) or Wi-Fi (registered trademark). For example, the communication unit 11 can communicate with the external keyboard 30 or the like described above by using Bluetooth (registered trademark).

A program or data for the process executed by the control unit 18 is loaded in the RAM 12, and various types of data are saved or deleted as appropriate. For example, the RAM 12 also functions as a display video memory (V-RAM) for display of the display 150. As an example, the RAM 12 functions as a video memory of data displayed in the screen area DA when the display 150 is controlled in the one-screen mode. Also, the RAM 12 functions as a video memory of data displayed in the first screen area DA1 and the second screen area DA2 when the display 150 is controlled in the two-screen mode. In addition, the RAM 12 stores information on the apps being executed, an app being used (app as the active window) out of the apps being executed, information on other apps as the inactive window, information on which screen area each window is displayed in, and the like. Since the RAM 12 is a volatile memory, the data is not held when the supply of power to the RAM 12 is stopped. The data that needs to be held when the supply of power to the RAM 12 is stopped is transferred to the storage unit 13.

The storage unit 13 includes one or a plurality of a solid state drive (SSD), a hard disk drive (HDD), a read only memory (ROM), a Flash-ROM, and the like. For example, the storage unit 13 saves a program or setting data of a basic input output system (BIOS), a program of an operating system (OS) or an app operating on the OS, various types of data used in the app, and the like.

The speaker 14 outputs an electronic sound, a voice, or the like.

The display unit 15 is provided with the display 150 and a touch sensor 155. As described above, the display 150 is a flexible display that can be bent according to the opening angle θ due to the relative rotation of the first chassis 101 and the second chassis 102. The display 150 performs display corresponding to each display mode described with reference to FIG. 4 according to the control of the control unit 18. The touch sensor 155 is provided on the screen of the display 150, and detects the touch operation on the screen. For example, the touch sensor 155 detects the touch operation on the screen area DA in the one-screen mode. The touch sensor 155 detects a touch operation on one or both of the first screen area DA1 and the second screen area DA2 in the two-screen mode. The touch operation includes a tap operation, a slide operation, a flick operation, a swipe operation, a pinch operation, and the like. The touch sensor 155 detects the touch operation to output operation information based on the detected operation to the control unit 18.

The camera 16 includes a lens, an imaging element, and the like. The camera 16 captures an image (a still image or a moving image) according to the control of the control unit 18 to output data of the captured image.

The first acceleration sensor 161 is provided inside the first chassis 101, and detects the orientation of the first chassis 101 and the change in the orientation. For example, assuming that a direction parallel to a longitudinal direction of the first screen area DA1 is an X1 direction, a direction parallel to a lateral direction is a Y1 direction, and a direction perpendicular to the X1 direction and the Y1 direction is a Z1 direction, the first acceleration sensor 161 detects acceleration in each of the X1 direction, the Y1 direction, and the Z1 direction to output the detection result to the control unit 18.

The second acceleration sensor 162 is provided inside the second chassis 102, and detects the orientation of the second chassis 102 and the change in the orientation. For example, assuming that a direction parallel to a longitudinal direction of the second screen area DA2 is an X2 direction, a direction parallel to a lateral direction is a Y2 direction, and a direction perpendicular to the X2 direction and the Y2 direction is a Z2 direction, the second acceleration sensor 162 detects acceleration in each of the X2 direction, the Y2 direction, and the Z2 direction to output the detection result to the control unit 18.

The hall sensor 17 is provided to detect the connection with the keyboard 30. For example, when the keyboard 30 is placed on the second screen area DA2 of the second chassis 102, a magnetic field changes due to approaching of the magnet provided inside the bottom surface of the keyboard 30, and a detection value (output value) from the hall sensor 17 changes. That is, the hall sensor 17 outputs different detection results according to whether or not the keyboard 30 is placed. Here, the hall sensor 17 is used to detect whether or not the keyboard 30 is placed, but the detection method is not limited thereto, and any detection method can be used.

The control unit 18 includes a processor such as a central processing unit (CPU), a graphic processing unit (GPU), or a microcomputer, and realizes various functions by the processor executing the programs (various programs such as the BIOS, the OS, and the app operating on the OS) stored in the storage unit 13 or the like. For example, the control unit 18 detects the posture (orientation) of the information processing apparatus 10 based on the detection results of the first acceleration sensor 161 and the second acceleration sensor 162. In addition, the control unit 18 detects, based on the detection results of the first acceleration sensor 161 and the second acceleration sensor 162, whether the information processing apparatus 10 is in the open state or closed state, and whether the information processing apparatus 10 is in the bent form or the flat form in the open state, or the like.

In addition, the control unit 18 detects the display mode switching operation (for example, the operation on the display mode switching icon illustrated in FIG. 5) by the user. In addition, the control unit 18 detects the connection with the keyboard 30 based on the detection result of the hall sensor 17. The connection with the keyboard 30 refers to the placement of the keyboard 30 on the second screen area DA2, and does not refer to communication connection. The control unit 18 detects the communication connection with the keyboard 30 by using a function of Bluetooth (registered trademark) or the like.

In addition, by detecting the state of the system, the posture (orientation) of the information processing apparatus 10, whether the information processing apparatus 10 is in the open state or closed state, and whether the information processing apparatus 10 is in the bent form or flat form when in the open state, the display mode switching operation by the user, connection with the keyboard 30, and the like, the control unit 18 performs control of the switching of the display mode of the display 150 described with reference to FIGS. 4 and 5, performs control of the rearrangement of windows when switching to the half-screen mode (when changing the screen layout) described with reference to FIG. 6, and the like.

### (Functional Configuration of Information Processing Apparatus 10)

Next, a functional configuration will be described, which is related to a display mode switching (change in the screen layout) process and the accompanying window rearrangement process, out of the processes executed by the control unit 18.

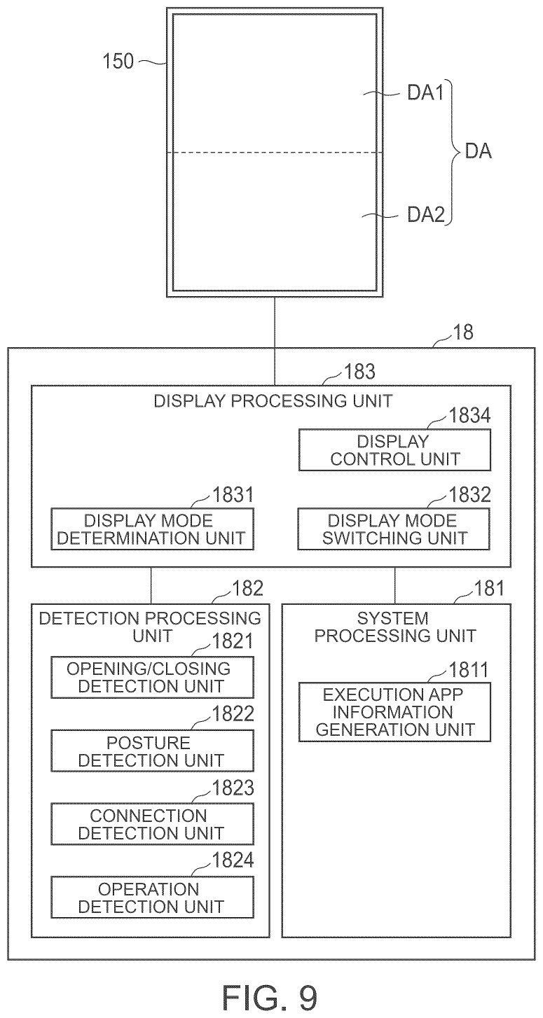

FIG. 9 is a block view illustrating an example of a functional configuration of the control unit 18 according to the present embodiment. The control unit 18 is provided with a system processing unit 181, a detection processing unit 182, and a display processing unit 183. Here, the system processing unit 181 has a functional configuration in which the CPU executes the process based on, for example, the OS or the BIOS. The detection processing unit 182 has a functional configuration in which the microcomputer other than, for example, the CPU that executes the process of the OS, the BIOS, or the like executes various detection processes. The display processing unit 183 has a functional configuration in which the CPU executes the process based on, for example, an OS or the program operating on the OS.

The system processing unit 181 executes an OS or various programs such as a driver, and an app operating on the OS. In addition, the system processing unit 181 includes, for example, an execution app information generation unit 1811. The execution app information generation unit 1811 generates app information including identification information (for example, an app ID) of the apps being executed, information indicating the app being used (that is, the app of which the window is active) by the user out of the apps being executed, and the like. The execution app information generation unit 1811 stores and holds the generated app information and the like in the RAM 12.

The detection processing unit 182 is provided with an opening/closing detection unit 1821, a posture detection unit 1822, and a connection detection unit 1823 as a functional configuration for detecting the state of the information processing apparatus 10. The detection processing unit 182 outputs the detection results by the opening/closing detection unit 1821, the posture detection unit 1822, and the connection detection unit 1823 to the display processing unit 183.

The opening/closing detection unit 1821 detects whether the information processing apparatus 10 is in the open state or the closed state based on the detection results of the first acceleration sensor 161 and the second acceleration sensor 162. In a case in which the information processing apparatus 10 is in the open state, the opening/closing detection unit 1821 detects an opening angle θ between the first chassis 101 and the second chassis 102 based on the detection results of the first acceleration sensor 161 and the second acceleration sensor 162. The opening/closing detection unit 1821 detects whether the information processing apparatus 10 is in the bent form or the flat form, based on the detected opening angle θ.

The posture detection unit 1822 detects the posture (orientation) of the information processing apparatus 10 based on the detection results of the first acceleration sensor 161 and the second acceleration sensor 162.

The connection detection unit 1823 performs a connection detection process of detecting connection to the keyboard 30. For example, the connection detection unit 1823 detects whether or not the keyboard 30 is placed on the second screen area DA2 based on the detection result of the hall sensor 17, to detect the connection with the keyboard 30. That is, the connection detection process of detecting the connection with the keyboard 30 corresponds to a placement detection process of determining whether the keyboard 30 is placed on the second screen area DA2. In a state in which the keyboard 30 is placed on the second screen area DA2, the connection detection unit 1823 detects that the keyboard 30 is connected.

In addition, the detection processing unit 182 is provided with an operation detection unit 1824 as a functional configuration for detecting the operation on the information processing apparatus 10. The operation detection unit 1824 detects the user's operation based on the operation information output from the touch sensor 155 provided on the screen of the display 150. For example, the operation detection unit 1824 acquires the operation information based on the user's operation on switching menus M1 and M2 (see FIG. 5) on which the display modes can be switched, and detects the display mode switching operation of switching between the display modes by the user based on the acquired operation information. The detection processing unit 182 outputs the detected operation information of the user to the display processing unit 183.

The display processing unit 183 determines and switches the display mode based on the detection results by the detection processing unit 182. In addition, the display processing unit 183 controls display of the windows (active window and inactive window) of the apps being executed, according to the display mode, based on the app information acquired from the system processing unit 181. Specifically, the display processing unit 183 includes a display mode determination unit 1831, a display mode switching unit 1832, and a display control unit 1834.

The display mode determination unit 1831 performs a determination process of determining the display mode based on the detection results by the detection processing unit 182. For example, the display mode determination unit 1831 acquires the detection results of the state of the information processing apparatus 10, the detection results of the connection with the keyboard 30, and the operation information of the user from the detection processing unit 182, and determines the display mode as described with reference to FIG. 4.

The display mode switching unit 1832 performs a display mode switching process of performing the switching to the display mode described with reference to FIG. 4, based on the display mode determined by the display mode determination unit 1831. For example, the display mode switching unit 1832 controls switching between the one-screen mode, the two-screen mode (or inverted two-screen mode), or the half-screen mode (that is, switching of the screen layout) based on the display mode determined by the display mode determination unit 1831.

In addition, in a case in which the connection detection unit 1823 detects the connection with the keyboard 30, the display mode switching unit 1832 switches the display mode to the half-screen mode (see FIGS. 4 and 6). As described above, the half-screen mode is a display mode in which the keyboard 30 is placed on the second screen area DA2 and only the first screen area DA1 is targeted for display.

The display control unit 1834 controls the display of the display 150. For example, the display control unit 1834 controls the position and size of windows to be displayed in each screen area according to the display mode set by the display mode switching unit 1832. In addition, the display control unit 1834 controls the display orientation in the screen area of the display 150 according to the orientation of the information processing apparatus 10 (orientation of the screen area of the display 150). In the half-screen mode, the display control unit 1834 controls the display in a preset display orientation regardless of the orientation of the information processing apparatus 10 (orientation of the screen area of the display 150). The preset display orientation is, for example, the orientation in which the side where the first chassis 101 and the second chassis 102 are connected is lower in the first screen area DA1 (that is, the orientation where the first screen area DA1 is on the upper side and the second screen area DA2 on which the keyboard 30 is placed is on the lower side).

In addition, when the screen layout is changed by switching the display mode, the display control unit 1834 rearranges the windows based on the position and size before the change, after the screen layout is changed. In addition, when rearranging the windows, the display control unit 1834 rearranges the windows in order according to the Z-order, while retaining the Z-order itself for each window. That is, the window that is most visible in the front on the screen is arranged first, and subsequent windows are arranged behind the arranged window in order.

For example, the display control unit 1834 performs a storage process of storing position and size information (for example, ID, position and size information) for each window before the screen layout is changed. This process is a process of acquiring events from the OS when a change in the position or size of a window occurs and updating the retained position and size information for each window to the position and size information after the change. This stored position and size information is used when the screen mode is switched from the half-screen mode back to the full-screen mode (for example, one-screen mode), and thus updating is performed only in the full-screen mode. In addition, as described above, the display control unit 1834 also stores the position and size information for each window, for example, even when the application is run, so that the latest information is retained at any time.

In addition, the display control unit 1834 always manages the Z-order of one or a plurality of windows arranged on the display 150. For example, the information processing apparatus 10 acquires events from the OS, such as when an application is run and a window is opened, when a window is focused (selected), and when a window is closed, and updates the Z-order information at the timing when there is a change in the Z-order. The Z-order information is updated even in the half-screen mode.

For example, in the control of the rearrangement of windows following a change in the screen layout described with reference to FIG. 6 above, the display control unit 1834 stores the position and size information for each window in the one-screen mode illustrated in view (A) of FIG. 6 (that is, before switching to the half-screen mode). In addition, the display control unit 1834 manages and stores the Z-order in the one-screen mode illustrated in view (A) of FIG. 6 (that is, before switching to the half-screen mode). Further, the display control unit 1834 continues to manage and store the Z-order even after switching to the half-screen mode illustrated in view (B) of FIG. 6 via the connection with the keyboard 30 (docking). When switching from the half-screen mode back to the one-screen mode due to disconnection (undocking) from the keyboard 30, the information processing apparatus 10 rearranges the windows based on the position and size information for each window stored before switching to the half-screen mode. At this time, the information processing apparatus 10 rearranges the windows in order according to the Z-order (the latest Z-order) that is managed in the half-screen mode.

### (Window Rearrangement Process Following Change in Screen Layout)

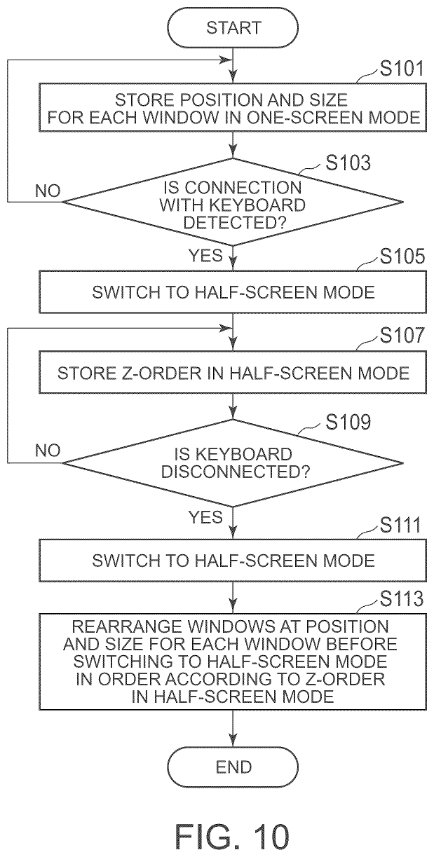

Next, an operation of the process by which the control unit 18 rearranges windows following a change in the screen layout will be described. First, with reference to FIG. 10, an overview of the operation of the window rearrangement process following a change in the screen layout will be described.

FIG. 10 is a flowchart showing an example of the window rearrangement process following a change in the screen layout according to the present embodiment. The process illustrated in FIG. 10 is illustrated as a flowchart of the process illustrated in FIG. 6 described above. For example, it is assumed that at the start of the process, a plurality of windows are arranged in the screen area DA of the display 150 in one-screen mode.

(Step S101) The control unit 18 stores the position and size information for each window arranged in the screen area DA in the one-screen mode. For example, the control unit 18 stores and updates the position and size information for each window when the application is run or when the position or size of a window is changed. In addition, the control unit 18 stores and manages the Z-order of windows in the one-screen mode. For example, the control unit 18 stores and updates the Z-order of windows arranged in the screen area DA in the one-screen mode at the timing when there is a change in the Z-order.

(Step S103) The control unit 18 determines whether or not a connection (docking) with the keyboard 30 is detected. In a case in which the control unit 18 determines that the connection with the keyboard 30 is not detected (NO), the process returns to step S101. On the other hand, in a case in which the control unit 18 determines that the connection with the keyboard 30 is detected (YES), the process advances to step S105.

(Step S105) The control unit 18 switches from the one-screen mode to the half-screen mode, controls the second screen area DA2 to be displayed black or turned off, and changes to a screen layout in which only the first screen area DA1 is targeted for display. Then, the process advances to step S107.

(Step S107) The control unit 18 manages the Z-order of windows in the half-screen mode. For example, the control unit 18 stores and updates the Z-order of windows arranged in the first screen area DA1 in the half-screen mode at the timing when there is a change in the Z-order. Then, the process advances to step S109.

(Step S109) The control unit 18 determines whether or not the keyboard 30 is disconnected (undocked). In a case in which the connection with the keyboard 30 is detected, the control unit 18 determines that the keyboard 30 is not disconnected (NO), and the process returns to step S107. On the other hand, in a case in which the connection with the keyboard 30 is no longer detected, the control unit 18 determines that the keyboard 30 is disconnected (YES), and the process advances to step S111.

(Step S111) The control unit 18 switches from the half-screen mode back to the one-screen mode and changes the screen layout to a screen layout in which the entire screen area DA is targeted for display. Then, the process advances to step S113.

(Step S113) The control unit 18 rearranges the windows in order according to the Z-order (Z-order in the half-screen mode) stored in step S107 at the position and size for each window stored in step S101 (position and size for each window before switching to the half-screen mode).

In the present embodiment, when rearranging windows following a change in the screen layout, the control unit 18 rearranges the windows based on the position and size of each window before the change in the screen layout, but may also rearrange the windows based on at least only position, out of position and size.

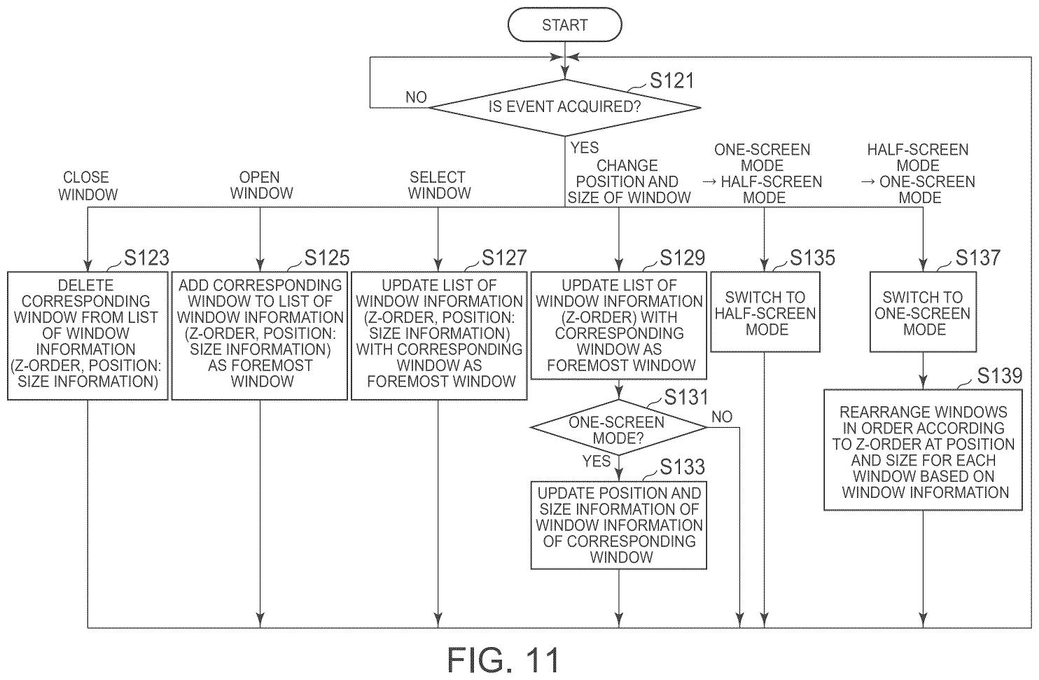

Next, with reference to FIG. 11, an operation example will be described in detail, in which an example of the process of managing window information by the control unit 18 in the window rearrangement process following a change in the screen layout is described.

FIG. 11 is a flowchart illustrating a detailed example of the window rearrangement process following a change in the screen layout according to the present embodiment.

(Step S121) The control unit 18 determines whether or not events are acquired. Here, events include window changes (open, close, focus, position and size changes) and switching between the one-screen mode and the half-screen mode. In a case in which it is determined that an event is not acquired (NO), the control unit 18 performs the process of step S121 again.

In a case in which the control unit 18 determines in step S121 that an event is acquired (YES), the process advances to step S123 in a case in which the event indicating that the window is closed is acquired.

(Step S123) The control unit 18 deletes the window (closed window) corresponding to the acquired event from the list of window information (see FIGS. 7(C) to 7(D)). That is, the control unit 18 deletes the window information of the window (closed window) corresponding to the acquired event from the list in which the Z-order and position and size information are stored. Then, the process returns to step S121.

In addition, in a case in which the control unit 18 determines that an event is acquired in step S121 (YES), and acquires an event indicating that a window is opened, the process advances to step S125.

(Step S125) The control unit 18 adds the window (open window) corresponding to the acquired event to the end of the list of window information (see FIGS. 7(A) to 7(B)). That is, the control unit 18 adds the window information (Z-order, position and size information) to the list with the window corresponding to the acquired event (the opened window) as the foremost window. Then, the process returns to step S121.

In addition, in a case in which the control unit 18 determines that an event is acquired in step S121 (YES), and acquires an event indicating that a window is focused (selected), the process advances to step S127.

(Step S127) The control unit 18 moves the window information of the window corresponding to the acquired event (selected window) to the end of the list (see FIGS. 7(B) to 7(C)). That is, the control unit 18 updates the list of window information (Z-order, position and size information) with the window corresponding to the acquired event (selected window) as the foremost window. Then, the process returns to step S121.

In addition, in a case in which the control unit 18 determines that an event is acquired in step S121 (YES), and acquires an event indicating that there is a change in the position or size of a window, the process advances to step S129.

(Step S129) The control unit 18 moves the window information of the window corresponding to the acquired event (the window whose position or size has changed) to the end of the list. That is, the control unit 18 updates the list of window information (Z-order) with the window corresponding to the acquired event (the window whose position or size has changed) as the foremost window. Then, the process advances to step S131.

(Step S131) The control unit 18 determines whether or not the one-screen mode is used. In a case in which the control unit 18 determines that the one-screen mode is used (step S131: YES), the process advances to step S133.

(Step S133) The control unit 18 updates the position and size information of the window information of the window corresponding to the acquired event (the window whose position or size has changed) to the information after the change. Then, the process returns to step S121.

On the other hand, in a case in which the control unit 18 determines that the one-screen mode is not used (step S131: NO), the process does not advance to step S133 and returns to step S121. That is, in a case in which the position or size of a window changes in the one-screen mode, the control unit 18 updates the Z-order and position and size information of the changed window, but in the half-screen mode, updates only the Z-order and does not update the position and size information.

In addition, in a case in which the control unit 18 determines that an event is acquired in step S121 (YES), and acquires an event indicating that there is a switch from the one-screen mode to the half-screen mode, the process advances to step S135.

(Step S135) The control unit 18 controls switching from the one-screen mode to the half-screen mode. At this time, the window is rearranged only in the first screen area DA1 under the control of the OS according to the change in resolution following the switch from the one-screen mode to the half-screen mode. Then, the process returns to step S121.

In addition, in a case in which the control unit 18 determines that an event is acquired in step S121 (YES), and acquires an event indicating that there is a switch from the half-screen mode to the one-screen mode, the process advances to step S137.

(Step S137) The control unit 18 performs control of switching from the half-screen mode to the one-screen mode. Then, the process advances to step S139.

(Step S139) Based on the Z-order and position and size information managed in the list of window information, the control unit 18 rearranges the windows in order according to the Z-order in the half-screen mode at the position and size for each window in the one-screen mode before switching to the half-screen mode. Then, the process returns to step S121.

As described above, the information processing apparatus 10 in the present embodiment includes the display 150, the RAM 12 (an example of a memory) that temporarily stores a program of an application, and the control unit 18 (an example of a configuration including a processor) that performs control of displaying windows of the application on the display by executing the program of the application stored in the RAM 12. The control unit 18 performs a screen layout change process of changing the layout of the area in which one or a plurality of windows can be displayed, within the screen area of the display 150. In addition, the control unit 18 performs a storage process of storing the position information for each window before the layout of the screen area is changed by the screen layout change process. In addition, the control unit 18 performs a management process of managing the Z-order of one or a plurality of windows arranged in the screen area of the display 150. After the layout of the screen area is changed by the screen layout change process, the control unit 18 performs a window rearrangement process of rearranging one or a plurality of windows in order according to the Z-order managed by the management process when rearranging one or a plurality of windows based on the position information for each window stored by the storage process.

As a result, after the layout of the screen area of the display 150 is changed, the information processing apparatus 10 rearranges the windows in order according to the Z-order when restoring the windows to the position thereof before the change, and thus there is a high possibility that the other windows will be arranged hidden by the foremost window. Therefore, when the information processing apparatus 10 rearranges the windows, the appearance of the plurality of windows being arranged in turn (a phenomenon called flashing, for example) can be made less visible and less noticeable, and the appearance will not look poor. Thus, the information processing apparatus 10 can properly control the arrangement of the windows when the layout of the screen area of the display 150 is changed.

For example, in the screen layout change process, the control unit 18 performs a change in the screen layout between the one-screen mode (an example of the first layout) in which the entire screen area of the display 150 is used as an area in which a window can be displayed and the half-screen mode (an example of the second layout) in which a part of the screen area of the display 150 is used as an area in which a window can be displayed. When switching back to the one-screen mode after changing from the one-screen mode to the half-screen mode by the screen layout change process, the control unit 18 rearranges the windows in the window rearrangement process based on the position information for each window stored by the storage process before changing from the one-screen mode to the half-screen mode, and when rearranging the windows, rearranges the windows in the order according to the Z-order immediately before switching from the half-screen mode back to the one-screen mode by referring to the Z-order managed by the management process.

As a result, when switching back to the one-screen mode after changing from the one-screen mode to the half-screen mode, the information processing apparatus 10 rearranges the windows at the positions before changing to the half-screen mode, in order according to the Z-order, and thus it is highly likely that other windows will be arranged hidden by the foremost window, and the appearance of the plurality of windows being arranged in turn (a phenomenon called flashing, for example) can be made less visible and less noticeable, and the appearance will not look poor. As described above, when the layout of the screen area of the display 150 is changed (for example, when changing from the one-screen mode to the half-screen mode and then back to the one-screen mode), the information processing apparatus 10 can properly control the arrangement of the windows because the windows can be restored to the original position thereof so that the arrangement of the windows is not one-sided and the appearance does not look poor when the windows are rearranged to the original positions.

In addition, the control unit 18 performs a placement detection process (for example, connection detection process of detecting the connection with the keyboard 30) of detecting the placement of the external keyboard 30 on a predetermined area (for example, the second screen area DA2) of the screen area of the display 150. In a case in which the placement of the keyboard 30 is detected by the placement detection process in the one-screen mode, the control unit 18 changes to the half-screen mode in which a part of the screen area of the display 150 (for example, the first screen area DA1), excluding the predetermined area, is an area in which a window can be displayed, by the screen layout change process.

As a result, when changing from a state using the screen area in the one-screen mode to the half-screen mode using an external keyboard 30 and then removing the keyboard 30 and using the screen area in the one-screen mode again, the information processing apparatus 10 rearranges the windows at the positions before the keyboard 30 was used, in order according to the Z-order, and thus it is highly likely that other windows will be arranged hidden in the foremost window, and the appearance of the plurality of windows being arranged in turn (a phenomenon called flashing, for example) can be made less visible and less noticeable, and the appearance will not look poor. As described above, when changing the layout of the screen area of the display 150 (for example, from changing a state using the screen area in the one-screen mode to the half-screen mode using the external keyboard 30, then removing the keyboard 30 and using the screen area in the one-screen mode again), the information processing apparatus 10 can properly control the arrangement of the windows because the windows can be restored to the original position thereof so that the arrangement of the windows will not be one-sided and the appearance will not look poor when the windows are rearranged to the original positions.

In addition, a control method in the information processing apparatus 10 according to the present embodiment includes, via the control unit 18 (an example of a configuration including a processor), a screen layout change step of changing the layout of an area in which one or a plurality of windows can be displayed within the screen area of the display 150, a storage step of storing the position information for each window before the layout of the screen area is changed by the screen layout change process, a management step of managing the Z-order of the one or the plurality of windows arranged in the screen area of the display 150, and a window rearrangement step of rearranging the one or the plurality of windows in order according to the Z-order managed by the management step when rearranging the one or the plurality of windows based on the position information for each window stored by the storage step, after changing the layout of the screen area by the screen layout change step.

As a result, in the control method in the information processing apparatus 10, after the layout of the screen area of the display 150 is changed, the information processing apparatus 10 rearranges the windows in order according to the Z-order when restoring the windows to the position thereof before the change, and thus it is highly likely that other windows will be arranged hidden in the foremost window, and the appearance of the plurality of windows being arranged in turn (a phenomenon called flashing, for example) can be made less visible and less noticeable, and the appearance will not look poor. Thus, in the control method in the information processing apparatus 10, it is possible to properly control the arrangement of windows when the layout of the screen area of the display 150 is changed.

### (Control Example When Window Is Minimized)

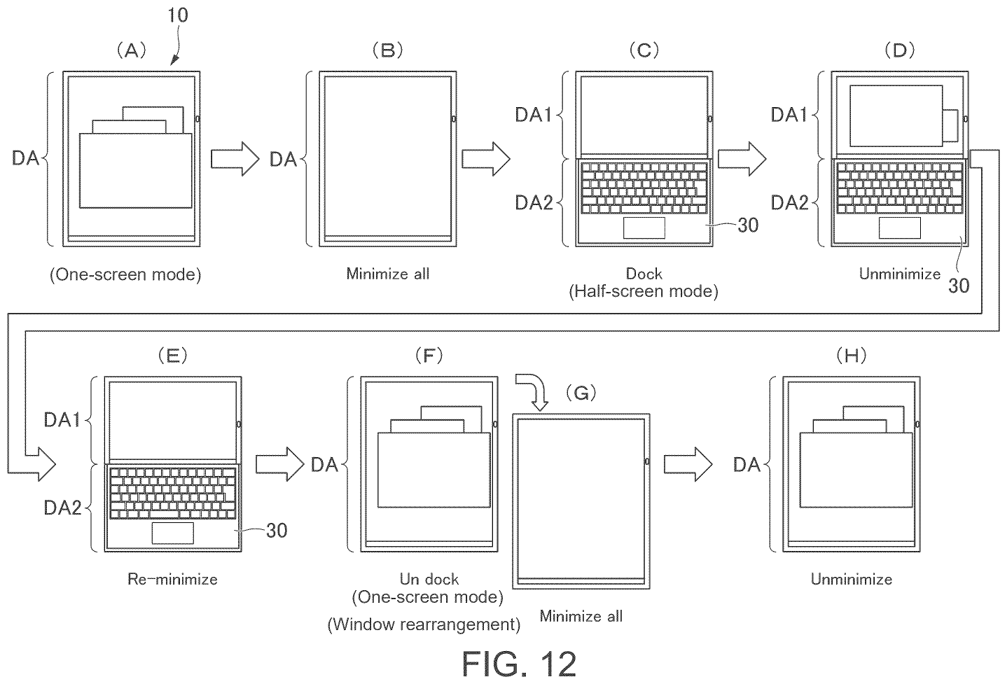

Here, when switching from the one-screen mode to the half-screen mode and then switching back to the one-screen mode, there is a demand for windows that were minimized before switching to the half-screen mode or before switching back to the one-screen mode to remain minimized. The same applies to maximized windows. An example of a case in which a window is minimized in the control of the rearrangement of windows following a change in the screen layout in the present embodiment will be described. FIG. 12 is a view illustrating another example of the rearrangement of windows following a change in the screen layout according to the present embodiment.

View (A) of FIG. 12 is an example similar to view (A) of FIG. 6, in which the information processing apparatus 10 controls the screen layout in which the entire screen area DA of the display 150 is targeted for display in the one-screen mode. Here, a plurality of windows are arranged in the screen area DA. In this one-screen mode (that is, before switching to the half-screen mode), the information processing apparatus 10 stores the position and size of each window in a process separate from the OS process.

As illustrated in view (B) of FIG. 12, when a user's operation or the like is performed to minimize all of the windows arranged in the screen area DA, the information processing apparatus 10 minimizes all of the windows that were arranged in the screen area DA.

Next, as illustrated in view (C) of FIG. 12, when the connection (docking) to the keyboard 30 is detected, the information processing apparatus 10 switches to half-screen mode, controls the second screen area DA2 to be displayed black or turned off, and changes to a screen layout in which only the first screen area DA1 is targeted for display. Since the screen area which is targeted for display is only half of the first screen area DA1 from the entire screen area DA, the resolution changes. The operating system (OS) of the information processing apparatus 10 rearranges the plurality of windows arranged in the screen area DA in one-screen mode to the first screen area DA1 by changing the position and size thereof according to the change in resolution, but in this example, all of the windows remain minimized. In addition, the information processing apparatus 10 manages the Z-order after switching to the half-screen mode in a process separate from the OS process.

As illustrated in view (D) of FIG. 12, when a window is unminimized by a user's operation or the like in the half-screen mode, the OS automatically arranges the unminimized window within the valid area of the first screen area DA1. When each window is minimized in view (B) of FIG. 12, the one-screen mode is used, but in view (D) of FIG. 12, the resolution is already changed to the half-screen resolution and each window is properly arranged within the first screen area DA1 by the OS.

Next, when a user's operation is performed to re-minimize all of the windows arranged in the first screen area DA1, as illustrated in view (E) of FIG. 12, the information processing apparatus 10 re-minimizes all of the windows arranged in the first screen area DA1.

As illustrated in view (F) of FIG. 12, when the connection with the keyboard 30 is no longer detected and the keyboard 30 is disconnected (undocked), the information processing apparatus 10 switches from the half-screen mode back to the one-screen mode. Here, it is desirable to leave windows that were minimized before switching back to the one-screen mode in that minimized state, but the information processing apparatus 10 temporarily rearranges each window in the screen area DA at the position and size stored in the one-screen mode shown in view (A) of FIG. 12 (that is, before switching to the half-screen mode). As a result, the OS can recognize the position and size of each window before switching to the half-screen mode. In addition, when rearranging each window temporarily, the information processing apparatus 10 rearranges the window in order according to the Z-order (the latest Z-order) that is managed in the half-screen mode. Thereafter, as illustrated in view (G) of FIG. 12, the information processing apparatus 10 minimizes the windows that were minimized in the half-screen mode in view (E) of FIG. 12 out of the windows that were temporarily rearranged in the screen area DA.

The windows that were minimized when switching the half-screen mode back to the one-screen mode remain minimized until the windows are rearranged as illustrated in view (F) of FIG. 12. Therefore, more specifically, the moment of switching from the half-screen mode illustrated in view (E) of FIG. 12 to the one-screen mode illustrated in view (F) of FIG. 12 is via the state similarly to the state illustrated in view (G) of FIG. 12, in which all of the windows are minimized in the one-screen mode. More specifically, in FIG. 12, the transition occurs in the order of views (E)-(G)-(F)-(G).

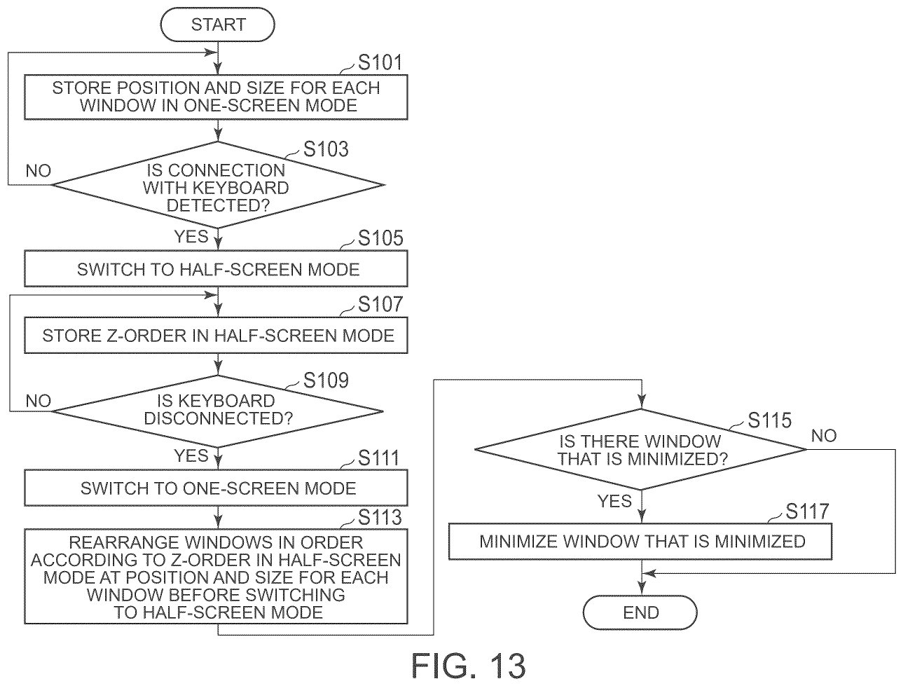

As a result, thereafter, in a case in which windows are unminimized by a user's operation and the like, as illustrated in view (H) of FIG. 12, the information processing apparatus 10 can also arrange the windows in the screen area DA at the position and size in the one-screen mode (that is, before switching to the half-screen mode) illustrated in view (A) of FIG. 12, even with the OS process. With reference to FIG. 13, an overview of the operation when there is a minimized window in the window rearrangement process following a change in the screen layout will be described.

FIG. 13 is a flowchart illustrating an example of a process when there is a minimized window in the window rearrangement process following a change in the screen layout according to the present embodiment. The process in steps S101 to S113 in FIG. 13 is similar to the process in steps S101 to S113 in FIG. 10, and therefore the description thereof will be omitted.

In step S113, the control unit 18 temporarily rearranges the windows in order according to the Z-order at the position and size for each window before switching to the half-screen mode. In a case in which all the windows are minimized when switching from the half-screen mode back to the one-screen mode, the windows remain minimized at the moment of switching to the one-screen mode in step S111, and then the windows are rearranged by the process in step S113. Thereafter, the process advances to step S115 to minimize the window.

(Step S115) The control unit 18 determines whether or not there is a window that is minimized when switching from the half-screen mode back to the one-screen mode in step S111. In a case in which it is determined that there is no minimized window (NO), the control unit 18 ends the process because there is no window to be minimized. On the other hand, in a case in which the control unit 18 determines that there is a minimized window (YES), the process advances to step S117.

(Step S117) The control unit 18 minimizes the windows that were minimized when switching from the half-screen mode back to the one-screen mode in step S111 out of the windows that were temporarily rearranged in step S113. For example, in a case in which all of the windows are minimized when switching from the half-screen mode back to the one-screen mode as illustrated in FIG. 10(E), the control unit 18 minimizes all of the windows as illustrated in FIG. 10(G).

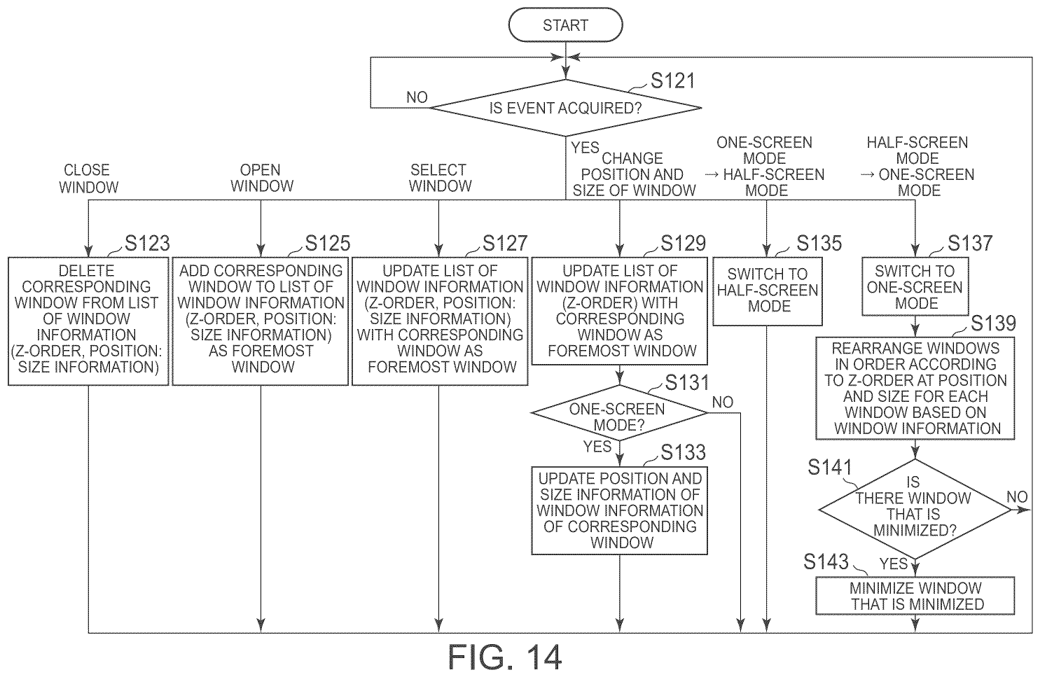

Next, with reference to FIG. 14, an operation example will be described in detail, in which an example of the process of managing window information by the control unit 18 in the window rearrangement process following a change in the screen layout is described.

FIG. 14 is a flowchart illustrating a detailed example when there is a minimized window in the window rearrangement process following a change in the screen layout according to the present embodiment. The process in steps S121 to S139 in FIG. 14 is similar to the process in steps S121 to S139 in FIG. 11, and therefore the description thereof will be omitted.

In step S139, when control unit 18 rearranges the windows in order according to the Z-order in the half-screen mode at the position and size for each window in the one-screen mode, the process advances to step S141. At this time, the windows that were minimized in the half-screen mode are temporarily unminimized and rearranged.

(Step S141) The control unit 18 determines whether or not there is a window that is minimized when switching from the half-screen mode to the one-screen mode in step S137. In a case in which the control unit 18 determines that there is no minimized window in the half-screen mode (NO), the process returns to step S121. On the other hand, in a case in which the control unit 18 determines that there is a minimized window (YES), the process advances to step S143.

(Step S143) The control unit 18 minimizes the windows that are minimized when switching from the half-screen mode back to the one-screen mode in step S137, and the process returns to step S121.

As described above, even when a window that was minimized in the half-screen mode remains minimized when switching from the half-screen mode back to the one-screen mode, when switching back to the one-screen mode, when switching back to the one-screen mode, by temporarily rearranging the window at the original position and size thereof before switching to the half-screen mode, and then minimizing the window, the information processing apparatus 10 allows the OS to recognize the original position and size of the window, and to restore the window to the original position and size when the window is unminimized. When rearranging the windows temporarily, the information processing apparatus 10 rearranges the windows in order according to the Z-order, and thus it is highly likely that other windows will be arranged hidden by the foremost window, making the windows less noticeable.

An example is described, in which windows that were minimized when switching from the half-screen mode to the one-screen mode are minimized after switching back to the one-screen mode, but a configuration in which windows that were minimized when switching from the one-screen mode to the half-screen mode are minimized after switching back from the half-screen mode to the one-screen mode may also be used. Also, similarly to a minimized window, a configuration in which windows that were maximized when switching from the half-screen mode back to the one-screen mode or windows that were maximized when switching from the one-screen mode to the half-screen mode are maximized after switching back to the one-screen mode may be used.

### Second Embodiment

Next, a second embodiment of the present invention will be described.

In the first embodiment, an example is described in which windows that were minimized (or maximized) when switching from the half-screen mode back to the one-screen mode are also rearranged to the original position and size thereof before switching to the half-screen mode, and thus the OS recognizes the original positions and size, and then the windows are minimized (or maximized). In this case, although the windows are rearranged in order according to the Z-order, the flashing phenomenon is noticeable due to another factor: the windows are temporarily rearranged before being minimized (or maximized) and then minimized (or maximized). This flashing phenomenon cannot be improved by the rearrangement process of windows in order according to the Z-order in the first embodiment.

Therefore, in the present embodiment, the information processing apparatus 10 does not rearrange the windows that were minimized (or maximized), and rearranges the windows at a point in time when the windows are unminimized (or unmaximized). As a result, when switching from the half-screen mode back to the one-screen mode, the information processing apparatus 10 can not only make the OS recognize the original position and size of the windows before switching to the half-screen mode but also make the appearance of the plurality of windows being arranged in turn (a phenomenon called flashing, for example) less visible and less noticeable.

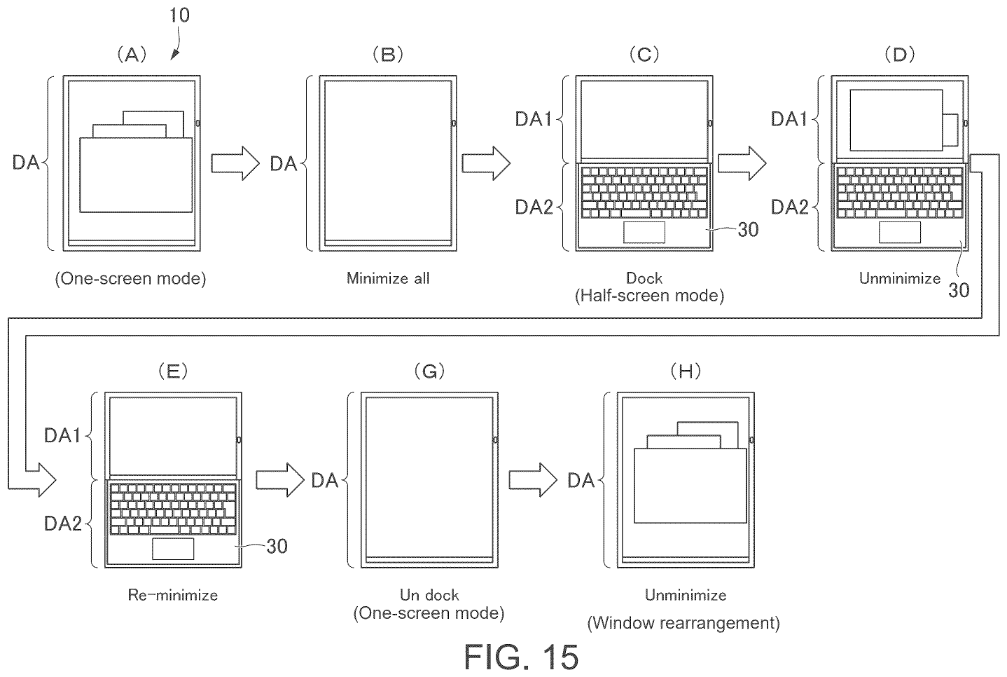

FIG. 15 is a view illustrating an example of the rearrangement of windows following a change in the screen layout according to the present embodiment. The example illustrated in FIG. 15 is an example in which the windows are minimized, similar to the example illustrated in FIG. 12, and differs from the example illustrated in FIG. 12 in that what happens after the keyboard 30 is disconnected (undocked) from the half-screen mode in view (E) of FIG. 15 and the layout switches back to the one-screen mode.

Since all of the windows are minimized in the half-screen mode of view (E) of FIG. 15, as illustrated in view (G) of FIG. 15, there is no window to be rearranged when the keyboard 30 is disconnected (undocked) and the layout is switched back to the one-screen mode, and all of the windows are minimized. That is, in the present embodiment, the flow from views (F) to (G) in FIG. 12 in the first embodiment does not occur.

Thereafter, in a case in which a minimized window is unminimized as illustrated in view (H) of FIG. 15, the information processing apparatus 10 rearranges the minimized window in the screen area DA at the position and size stored in the one-screen mode (that is, before switching to the half-screen mode) illustrated in view (A) of FIG. 15. For example, whenever the user performs an operation to unminimize a minimized window, the information processing apparatus 10 rearranges the operated window in the screen area DA at the position and size stored in the one-screen mode (that is, before switching to the half-screen mode) illustrated in view (A) of FIG. 15. That is, at this time, the information of the Z-order is not used when rearranging the windows. As described above, by rearranging the windows one by one each time the windows are unminimized, it is possible to make the appearance of the plurality of windows being arranged in turn (a phenomenon called flashing, for example) less visible and less noticeable. In addition, since the unminimized windows to be operated are focused (selected) at the same time, the information processing apparatus 10 also updates the Z-order information. That is, the information processing apparatus 10 moves the information of the window to the end of the list. In a case in which a plurality of windows are simultaneously unminimized, the information processing apparatus 10 rearranges the windows in order according to the Z-order (latest Z-order) managed in the half-screen mode.

In a case in which there is a window that is not minimized in the half-screen mode in view (E) of FIG. 15, the window will be rearranged when the keyboard 30 is disconnected (undocked) and the layout switches back to the one-screen mode. In a case in which there are a plurality of windows to be rearranged, the windows are rearranged in order according to the Z-order (the latest Z-order) that is managed in the half-screen mode.

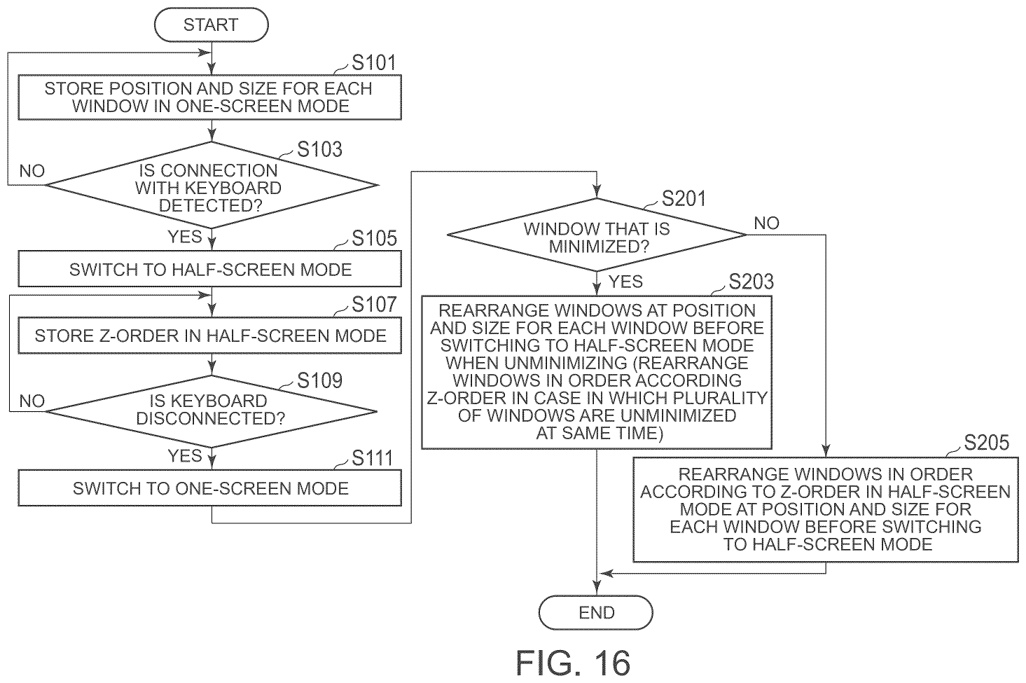

With reference to FIG. 16, an overview of the operation in the present embodiment when there is a minimized window in the window rearrangement process following a change in the screen layout will be described.

FIG. 16 is a flowchart showing an example of the window rearrangement process following a change in the screen layout according to the present embodiment. The process in steps S101 to S111 in FIG. 16 is similar to the process in steps S101 to S111 in FIGS. 10 and 13, and therefore the description thereof will be omitted.

In a case in which the control unit 18 switches from the half-screen mode back to the one-screen mode in step S111, the process advances to step S201.

(Step S201) The control unit 18 determines whether or not there is a window that is minimized when switching from the half-screen mode back to the one-screen mode in step S111. In a case in which the control unit 18 determines that there is a minimized window (YES), the process advances to step S203. On the other hand, in a case in which the control unit 18 determines that there is no minimized window (YES), the process advances to step S205.

(Step S203) The control unit 18 rearranges the minimized windows at the position and size for each window stored in step S101 (position and size for each window before switching to the half-screen mode) at a point in time when the windows are unminimized. In addition, in a case in which a plurality of minimized windows are simultaneously unminimized, the control unit 18 rearranges the windows in order according to the Z-order stored in step S107 (Z-order in the half-screen mode).

(Step S205) The control unit 18 rearranges the windows in order according to the Z-order (Z-order in the half-screen mode) stored in step S107 at the position and size for each window stored in step S101 (position and size for each window before switching to the half-screen mode).

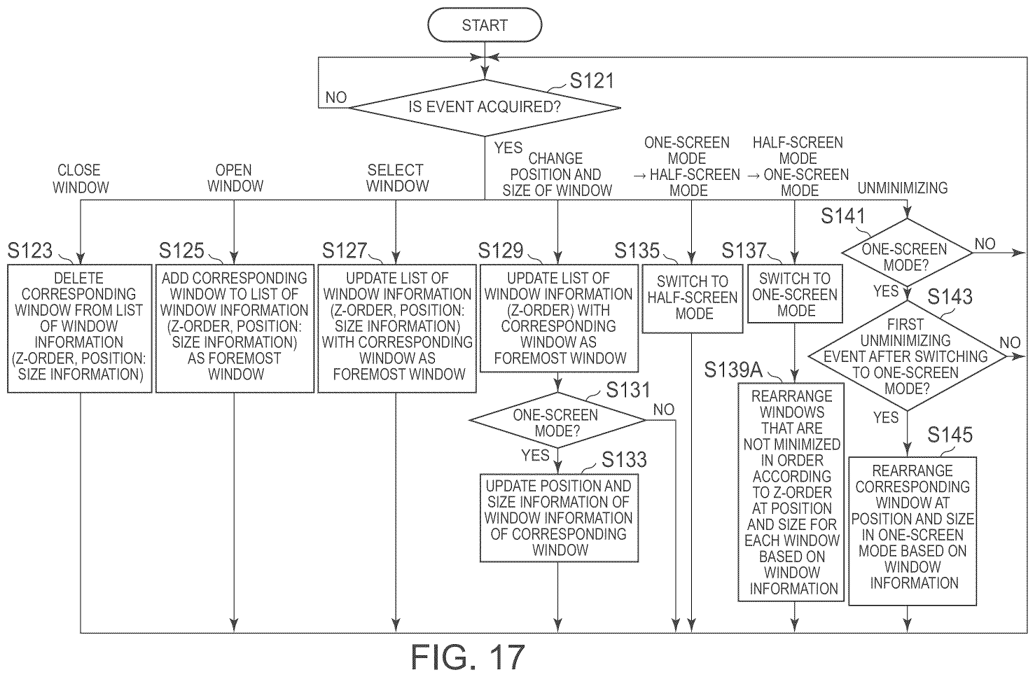

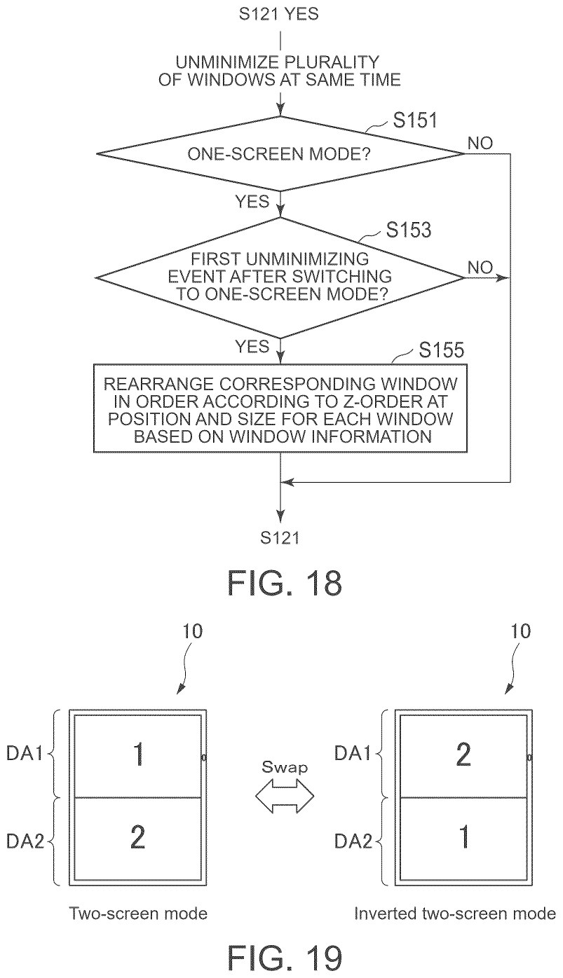

Next, with reference to FIGS. 17 and 18, an operation example will be described in detail, in which an example of the process of managing window information by the control unit 18 in the window rearrangement process following a change in the screen layout is described.

FIG. 17 is a flowchart illustrating a detailed example of the window rearrangement process following a change in the screen layout according to the present embodiment. The process in steps S121 to S137 in FIG. 17 is similar to the process in steps S121 to S137 in FIGS. 11 and 14, and therefore the description thereof will be omitted.

In a case in which the control unit 18 switches from the half-screen mode back to the one-screen mode in step S137, the process advances to step S139A. In step S139A, the control unit 18 rearranges windows that were not minimized based on the window information. Specifically, the control unit 18 rearranges the windows that were not minimized in order according to the Z-order in the half-screen mode at the position and size for each window in the one-screen mode based on the window information. At this time, windows that were minimized when switching from the half-screen mode to the one-screen mode remain minimized.

In addition, in a case in which the control unit 18 determines that an event is acquired in step S121 (YES), and the event is an unminimizing event for unminimizing any one of the windows, the process advances to step S141.

(Step S141) The control unit 18 determines whether or not the one-screen mode is used. In a case in which the control unit 18 determines that the one-screen mode is used (YES), the process advances to step S143. On the other hand, in a case in which the control unit 18 determines that the one-screen mode is not used (NO), the process does not advance to step S143 but returns to step S121. That is, the process of unminimizing is left to the OS.

(Step S143) The control unit 18 determines whether or not this event is a first unminimizing event after switching to the one-screen mode for the window corresponding to the acquired event (the window to be unminimized). In a case in which the control unit 18 determines that the event is the first unminimizing event (YES), the process advances to step S145. On the other hand, in a case in which the control unit 18 determines that the event is not the first unminimizing event (NO), the process does not advance to step S145 and returns to step S121. That is, the process of unminimizing is left to the OS.

(Step S145) The control unit 18 unminimizes the window corresponding to the acquired event (the window to be unminimized), and rearranges the window at the position and size of the window in the one-screen mode before switching to the half-screen mode, based on the position and size information managed in the list of window information. Then, the process returns to step S121. At the same time, the control unit 18 moves the information of the window to the end of the list since the window is focused.

FIG. 18 is a flowchart illustrating an example of the rearrangement process when a plurality of minimized windows are simultaneously unminimized, according to the present embodiment. In FIG. 18, a part of processing in a case where the minimization of the plurality of windows is simultaneously released in the processing illustrated in FIG. 17 is extracted and shown. In a case in which the control unit 18 determines that an event is acquired in step S121 (YES), and the event is an unminimizing event indicating that a plurality of windows are to be unminimized at the same time, the process advances to step S151.

(Step S151) The control unit 18 determines whether or not the one-screen mode is used. In a case in which the control unit 18 determines that the one-screen mode is used (YES), the process advances to step S153. On the other hand, in a case in which the control unit 18 determines that the one-screen mode is not used (NO), the process does not advance to step S153 but returns to step S121. That is, the process of unminimizing is left to the OS.

(Step S153) The control unit 18 determines whether or not this event is the first unminimizing event after switching from the half-screen mode to the one-screen mode for each of the windows corresponding to the acquired event (the window to be unminimized). In a case in which the control unit 18 determines that the event is the first unminimizing event (YES), the process advances to step S155. On the other hand, in a case in which the control unit 18 determines that the event is not the first unminimizing event (NO), the process does not advance to step S155 and returns to step S121. That is, for windows that are not the target of the first unminimizing event, the process of unminimizing is left to the OS.

(Step S155) The control unit 18 unminimizes the window, which is the target of the first unminimizing event, out of the windows corresponding to the acquired event (the windows to be unminimized), which is the target of the first unminimizing event, and rearranges the windows in order according to the Z-order in the half-screen mode at the position and size of the window in the one-screen mode before switching to the half-screen mode based on the Z-order and position and size information managed in the list of window information. Then, the process returns to step S121.

As described above, when an unminimizing event is acquired, indicating that a plurality of windows are to be unminimized at the same time, in a case in which the windows to be unminimized are mixed with a window that is the first to be unminimized after switching from the half-screen mode to the one-screen mode and a window that is the second or subsequent to be unminimized, the control unit 18 performs the window rearrangement process in step S155 on the window that is the first to be unminimized, but does not perform the process in step S155 on the window that is the second or subsequent to be unminimized, and leaves the process of unminimizing to be performed by the OS. In a case in which all of the windows to be unminimized are the first to be unminimized after switching from the half-screen mode to the one-screen mode, the control unit 18 performs the window rearrangement process in step S155 on all such windows.

An example is described, in which windows that were minimized when switching from the half-screen mode to the one-screen mode are minimized after switching back to the one-screen mode, but a configuration in which windows that were minimized when switching from the one-screen mode to the half-screen mode are minimized after switching back from the half-screen mode to the one-screen mode may also be used. Also, similarly to a minimized window, a configuration in which windows that were maximized when switching from the half-screen mode back to the one-screen mode or windows that were maximized when switching from the one-screen mode to the half-screen mode are maximized after switching back to the one-screen mode may be used.

As described above, in the information processing apparatus 10 according to the present embodiment, when switching from the half-screen mode (an example of the second layout) back to the one-screen mode (an example of the first layout), the control unit 18 does not execute the window rearrangement process of rearranging windows that were minimized or maximized when switching back to the one-screen mode, but executes the window rearrangement process to rearrange the unminimized or unmaximized windows when the minimized or maximized windows are unminimized or unmaximized.

As a result, when changing from the one-screen mode to the half-screen mode and then back to the one-screen mode, the information processing apparatus 10 continues to minimize or maximize windows that were minimized or maximized in the half-screen mode, and rearranges the windows when the minimized or maximized windows are unminimized or unmaximized, and thus the windows will not be temporarily rearranged and then minimized or maximized, and the appearance will not look poor. Thus, the information processing apparatus 10 can properly control the arrangement of windows when the layout of the screen area of the display 150 is changed.

When switching from the half-screen mode back to the one-screen mode, the control unit 18 does not execute the window rearrangement process for windows that were minimized or maximized when changing from the one-screen mode to the half-screen mode, but may execute the window rearrangement process to rearrange the unminimized or unmaximized windows when the minimized or maximized windows are unminimized or unmaximized.

As a result, when changing from the one-screen mode to the half-screen mode and then back to the one-screen mode, the information processing apparatus 10 continues to minimize or maximize windows that were minimized or maximized before changing to the half-screen mode, and rearranges the windows when the minimized or maximized windows are unminimized or unmaximized, and thus the windows will not be temporarily rearranged and then minimized or maximized, and the appearance will not look poor. Thus, the information processing apparatus 10 can properly control the arrangement of windows when the layout of the screen area of the display 150 is changed.

### Third Embodiment

Next, a third embodiment of the present invention will be described. In the first and second embodiments, as an example of controlling the rearrangement of windows following a change in the screen layout, an example of controlling the rearrangement of windows when switching from the one-screen mode to the half-screen mode and then back to the one-screen mode is described. In the present embodiment, as another example of controlling the rearrangement of windows following a change in the screen layout, an example of controlling the rearrangement of windows when, for example, in the two-screen mode, the display of the first screen area DA1 and the display of the second screen area DA2 are swapped (switching from the two-screen mode to the inverted two-screen mode, or vice versa) will be described.

FIG. 19 is a view illustrating an example of a change in the screen layout according to the present embodiment. In this figure, “1” and “2” are attached to distinguish the display area in the two-screen mode as in FIG. 5. When the first screen area DA1 is set as a display area “1” and the second screen area DA2 as a display area “2” in the two-screen mode, if the display of each screen area is swapped, the display switches to the inverted two-screen mode, in which the first screen area DA1 is the display area “2” and the second screen area DA2 is the display area “1”. In addition, if the display of each screen area is swapped in the inverted two-screen mode, the display switches to the two-screen mode.

When swapping the display of each screen area in the two-screen mode, the windows displayed in the first screen area DA1 and the second screen area DA2 are not necessarily the first or second in the Z-order. For example, when the user selects a window that is arranged in a lower layer of a window displayed in the first screen area DA1 (primary) from the toolbar and displays the window as an active window, the Z-order changes, and the window displayed in the second screen area DA2 (secondary) may be the third or subsequent in the Z-order. Therefore, when switching from the two-screen mode to the inverted two-screen mode, simply rearranging windows in order according to the Z-order does not necessarily mean that windows are rearranged in order from the foremost window.

Therefore, when swapping the display of each screen area in the two-screen mode, the information processing apparatus 10 first swaps and rearranges the window that is arranged in the foremost side (top layer) of the first screen area DA1 and the window that is arranged in the foremost side (top layer) of the second screen area DA2. Next, the information processing apparatus 10 rearranges the remaining windows in order according to the Z-order.

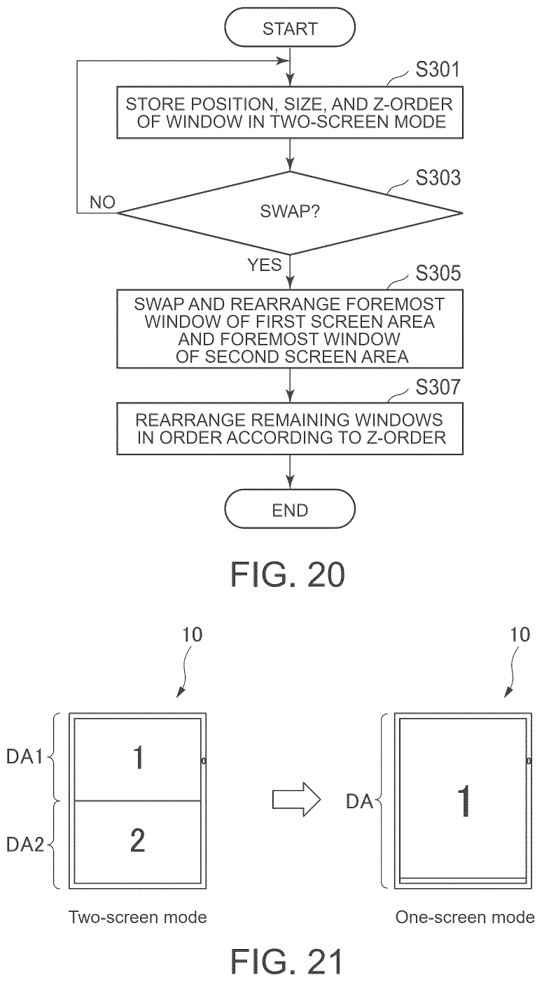

FIG. 20 is a flowchart showing an example of the window rearrangement process following a change in the screen layout according to the present embodiment. Here, the operation of the window rearrangement process when switching from the two-screen mode to the half-screen mode will be described.

(Step S301) The control unit 18 stores the position and size information and Z-order for each window arranged in the first screen area DA1 and the second screen area DA2 in the two-screen mode. For example, the control unit 18 stores and updates the position and size information for each window or the Z-order when the application is run, when the position or size of a window is changed, when the Z-order changes, and the like. This can be performed by the same method as the management of the Z-order described in the first and second embodiments. The event of swapping the order is an event such as focus on each window. The process advances to step S303.

(Step S303) The control unit 18 determines whether or not the display of each screen area is swapped in the two-screen mode. For example, in the two-screen mode illustrated in FIG. 14, in a case where an operation of selecting the display mode switching icon C23 of the switching menu M2 illustrated in FIG. 5(C) is performed, the control unit 18 determines that the display of each screen area is swapped (YES), and the process advances to step S305. On the other hand, in a case in which the control unit 18 determines that the display of each screen area is not swapped in the two-screen mode (NO), the process returns to step S301.

(Step S305) The control unit 18 swaps and rearranges the window arranged in the foremost side (top layer) of the first screen area DA1 and the window arranged in the foremost side (top layer) of the second screen area DA2 in the two-screen mode, and switches from the two-screen mode to the inverted two-screen mode. Then, the process advances to step S307.

(Step S307) The control unit 18 rearranges the remaining windows that are not rearranged in step S305 in order according to the Z-order in the two-screen mode before switching to the inverted two-screen mode.

As described above, in the information processing apparatus 10 according to the present embodiment, the control unit 18 changes the screen layout to swap the display of the first screen area DA1 (an example of a first area) and the display of the second screen area DA2 (an example of a second area) in the screen area of the display 150 in the two-screen mode (an example of a layout split into a plurality of areas) including the first screen area DA and the second screen area DA2 by the screen layout change process. In a case in which the screen layout is changed to swap the display of the first screen area DA1 and the display of the second screen area DA2, the control unit 18 swaps and rearranges the first window that is arranged in the foremost side out of the windows arranged in the first screen area DA1 and the second window that is arranged in the foremost side out of the windows arranged in the second screen area DA2, based on the position information for each window stored by the storage process before the change in the screen layout and the Z-order managed by the management process, in the window rearrangement process. Thereafter, the control unit 18 rearranges the windows other than the first window and the second window in order according to the Z-order managed by the management process.

As a result, when swapping the display in each screen area in the two-screen mode, the information processing apparatus 10 swaps the foremost window in each screen area and then rearranges the remaining windows, and thus the appearance of the plurality of windows being arranged in turn (a phenomenon called flashing, for example) can be made less visible and less noticeable, and the appearance will not look poor. Thus, the information processing apparatus 10 can properly control the arrangement of windows when the layout of the screen area of the display 150 is changed.

In the two-screen mode, inactive windows are arranged in a lower layer than the foremost window in the first screen area DA1 (primary), which creates a problem with the present embodiment in that, depending on the Z-order, windows are not necessarily rearranged in order from the foremost side when the display of each screen area is swapped. Therefore, when switching from the one-screen mode to the two-screen mode, the information processing apparatus 10 may minimize windows other than the foremost window in each screen area, and rearrange the windows at the original position thereof when switching back to the one-screen mode.

For example, when changing from the one-screen mode (an example of the first layout) to the two-screen mode (an example of the third layout), in the window rearrangement process, the control unit 18 minimizes the windows other than the foremost window in each of the first screen area DA1 and the second screen area DA2 in the two-screen mode. When changing from the two-screen mode back to the one-screen mode, the control unit 18 unminimizes the windows minimized in the two-screen mode and rearranges the windows based on the position information for each window stored by the storage process before changing from the one-screen mode to the two-screen mode and the Z-order managed by the management process.

In the present embodiment, the window rearrangement process when swapping the display of the first screen area DA1 (an example of the first area) and the display of the second screen area DA2 (an example of the second area) in the two-screen mode is described, but is not limited to the two-screen mode. For example, the present invention can be similarly applied when swapping the display of each screen area in a screen layout in which the screen area of the display 150 is split into three or more areas.

### Fourth Embodiment

Next, a fourth embodiment of the present invention will be described. In the present embodiment, as another example of controlling the rearrangement of windows following a change in the screen layout, for example, an example of controlling the rearrangement of windows when switching from the two-screen mode to the one-screen mode will be described. FIG. 21 is a view illustrating an example of a change in the screen layout according to the present embodiment. As illustrated, even when switching from the two-screen mode, in which the screen area DA is split into two parts, the first screen area DA1 and the second screen area DA2, to the one-screen mode, in which the entire screen area DA is used as an area in which windows can be displayed, the information processing apparatus 10 rearranges the windows in order according to the Z-order. As a result, when the foremost window is arranged first and the other windows are arranged later, it is highly likely that the other windows will be hidden by the foremost window, thereby making the windows less noticeable.

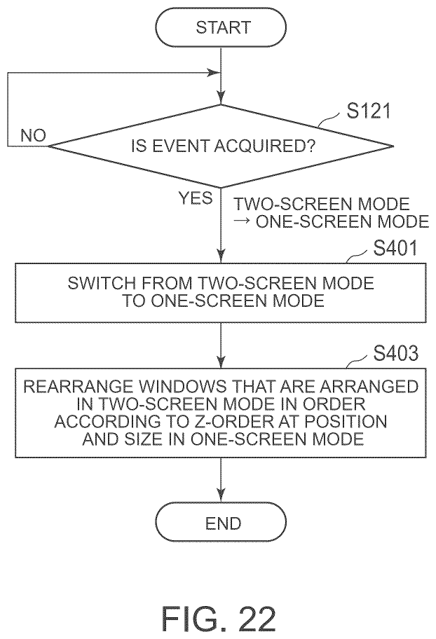

FIG. 22 is a flowchart showing an example of the window rearrangement process following a change in the screen layout according to the present embodiment. With reference to this figure, the operation of the window rearrangement process when switching from the two-screen mode to the one-screen mode will be described.

FIG. 22 illustrates the process when an event indicating a switch from the two-screen mode to the one-screen mode is acquired in step S121 illustrated in FIG. 11. As described with the processes in steps S123 to S133 in FIG. 11, the control unit 18 manages Z-order information in each screen mode. In addition, in at least the one-screen mode, the control unit 18 updates and manages the position and size information for each window when there is a change in the position or size of a window.

The control unit 18 determines whether or not an event is acquired in step S121, and in a case in which it is determined that an event indicating a switch from the two-screen mode to the one-screen mode is acquired (YES), the process advances to step S401.

(Step S401) The control unit 18 performs control of switching from the two-screen mode to the one-screen mode. Then, the process advances to step S403.

(Step S403) The control unit 18 rearranges the windows that are arranged in the first screen area DA1 and the second screen area DA2 in the two-screen mode to the screen area DA based on the position and size information for each window and the Z-order managed in the list of window information. Specifically, the control unit 18 rearranges the windows in the screen area DA in order according to the Z-order in the two-screen mode at the position and size for each window in the one-screen mode before switching to the two-screen mode.

As described above, in the information processing apparatus 10 according to the present embodiment, in the screen layout change process, the control unit 18 changes between the one-screen mode (an example of the first layout), in which the entire screen area of the display 150 is used as an area in which windows can be displayed, and the two-screen mode (an example of the third layout), in which the screen area of the display 150 is split into a plurality of areas. When changing from the two-screen mode to the one-screen mode, the control unit 18 rearranges one or a plurality of windows in an order according to the Z-order managed by the management process in the window rearrangement process.

As a result, when changing from the two-screen mode to the one-screen mode, the information processing apparatus 10 rearranges the windows in order according to the Z-order, and thus it is highly likely that other windows will be arranged hidden by the foremost window, and the appearance of the plurality of windows being arranged in turn (a phenomenon called flashing, for example) can be made less visible and less noticeable, and the appearance will not look poor. Thus, the information processing apparatus 10 can properly control the arrangement of windows when the layout of the screen area of the display 150 is changed.

The window rearrangement process when switching from the two-screen mode to the one-screen mode is described in the present embodiment, but is not limited to the two-screen mode. For example, the present invention can be similarly applied when switching from a screen layout in which the screen area of the display 150 is split into three or more areas to the one-screen mode.

Although the embodiments of the present invention have been described above in detail with reference to the accompanying drawings, a specific configuration is not limited to the above-described configuration, and various design changes and the like can be made without departing from the gist of the present invention. For example, the configurations described in the above-described embodiments may be optionally combined.

In addition, in the above embodiments, an example of detecting the connection (placement) with the keyboard 30 by using a hall sensor 17 is described, but the detection method is not limited thereto. For example, a configuration may be adopted in which a photosensor, a mechanical switch, or the like is used to detect the connection (placement) with the keyboard 30.

In addition, in the above-described embodiments, an example is described in which the display 150 is a single foldable display and the single display is used in the one-screen mode, two-screen mode, inverted two-screen mode, half-screen mode, and the like, but the display 150 may be configured to include a plurality of displays (for example, two). For example, a one-screen mode can be used in which each screen area of two displays is combined into one screen area and the display is controlled as the screen area DA, or a two-screen mode can be used in which the display of each screen area of two displays is controlled individually. In addition, the process in each of the above embodiments can also be applied as a half-screen mode, in which only one of the two displays is targeted for display and the other is controlled to be displayed black, turned off, and the like. Furthermore, one or both of the two displays may be used as a three- or four-screen mode by splitting the screen area into two separate display areas.

In the above-described embodiments, the example of the touch operation on the plurality of touch panel type displays in which the input unit (touch sensor) and the display unit are integrally configured has been described, but the present invention is not limited to the touch operation, and a click operation using a mouse, an operation using a gesture, or the like may be performed.

The information processing apparatus 10 described above has a computer system inside. The process in each configuration of the information processing apparatus 10 described above may be performed by recording a program for realizing the function of each configuration of the information processing apparatus 10 described above on a computer-readable recording medium, and reading the program recorded on the recording medium with the computer system to execute the program. Here, “reading the program recorded on the recording medium into the computer system to execute the program” includes installing the program in the computer system. The “computer system” herein includes the OS or hardware such as peripheral devices. In addition, the “computer system” may include a plurality of computer apparatuses connected via a network including a communication line such as the Internet, a WAN, a LAN, or a dedicated line. In addition, the “computer-readable recording medium” is a portable medium such as a flexible disk, a magneto-optical disk, a ROM, or a CD-ROM, and a storage device such as a hard disk built in the computer system. As described above, the recording medium that stores the program may be a non-transitory recording medium such as a CD-ROM.

In addition, the recording medium also includes an internal or external recording medium that can be accessed from a distribution server to distribute the program. A configuration may be used in which the program is split into a plurality of programs, downloaded at different timings from each other, and then combined with each configuration of the information processing apparatus 10, or distribution servers for distributing the respective split programs may be different. Further, the “computer-readable recording medium” includes a medium, which holds the program for a certain period of time, such as a volatile memory (RAM) inside the computer system that serves as a server or a client in a case in which the program is transmitted via the network. The above-described program may be a program for realizing a part of the above-described functions. Further, the program may be a so-called difference file (difference program) in which the above-described functions can be realized in combination with the program already recorded in the computer system.

A part or all of the functions of the information processing apparatus 10 in the above-described embodiments may be realized by an integrated circuit such as a large scale integration (LSI). Each of the functions may be individually realized as a processor, and a part or all of the functions may be integrated into a processor. A method of achieving the integrated circuit is not limited to the LSI, and may be realized by a dedicated circuit or a general-purpose processor. In a case in which advances in a semiconductor technique lead to appearance of an integrated circuit technique that replaces the LSI, an integrated circuit based on the technique may be used.

### DESCRIPTION OF SYMBOLS

10 information processing apparatus
101
first chassis
102 second chassis
103 hinge mechanism
11 communication unit
12 RAM
13 storage unit
14 speaker
15 display unit
16 camera
150 display
155 touch sensor
161 first acceleration sensor
162 second acceleration sensor
17 hall sensor
18 control unit
181 system processing unit
1811 execution app information generation unit
182 detection processing unit
1821 opening/closing detection unit
1822 posture detection unit
1823 connection detection unit
1824 operation detection unit
183 display processing unit
1831 display mode determination unit
1832 display mode switching unit
1834 display control unit

What is claimed is:

1. An information processing apparatus comprising:
a display;
a memory configured to temporarily store a program of an application; and
a processor configured to perform control of displaying windows of the application on the display by executing the program of the application stored in the memory, wherein
the processor is configured to perform:
a screen layout change process of changing a layout of an area in which one or a plurality of the windows are displayable, within a screen area of the display,
a storage process of storing position information for each window before the layout of the screen area is changed by the screen layout change process,
a management process of managing a Z-order of the one or the plurality of windows arranged in the screen area of the display, and
a window rearrangement process of rearranging the one or the plurality of windows in order according to the Z-order managed by the management process, when rearranging the one or the plurality of windows based on the position information for each window stored by the storage process, after the layout of the screen area is changed by the screen layout change process.

2. The information processing apparatus according to claim 1, wherein
the processor is configured to:
in the screen layout change process, perform a change between a first layout in which an entire screen area of the display is used as the area in which the windows are displayable and a second layout in which a part of the screen area of the display is used as the area in which the windows are displayable, and
when the layout is changed from the first layout to the second layout and back to the first layout by the screen layout change process, in the window rearrangement process, rearrange the windows based on the position information for each window stored by the storage process before changing the layout from the first layout to the second layout, and when rearranging the windows, rearrange the windows in order according to the Z-order immediately before changing the layout from the second layout back to the first layout by referring to the Z-order managed by the management process.

3. The information processing apparatus according to claim 2, wherein
the processor is configured to:
perform a placement detection process of detecting placement of an external keyboard on a predetermined area of the screen area of the display, and
when the placement of the keyboard is detected by the placement detection process in the first layout, change the layout to the second layout in which the part of the screen area of the display, excluding the predetermined area, is the area in which the windows are displayable by the screen layout change process.

4. The information processing apparatus according to claim 2, wherein
the processor is configured, when the layout is changed from the second layout back to the first layout by the screen layout change process, not to execute the window rearrangement process on the windows that are minimized or maximized when changing the layout back to the first layout, and when the minimized or maximized windows are unminimized or unmaximized, to execute the window rearrangement process to rearrange the unminimized or unmaximized windows.

5. The information processing apparatus according to claim 2, wherein
the processor is configured, when the layout is changed from the second layout back to the first layout by the screen layout change process, not to execute the window rearrangement process on the windows that are minimized or maximized when changing the layout from the first layout to the second layout, and when the minimized or maximized windows are unminimized or unmaximized, execute the window rearrangement process to rearrange the unminimized or unmaximized windows.

6. The information processing apparatus according to claim 1, wherein
the processor is configured to:
in the screen layout change process,
perform a layout change of swapping display of a first area and display of a second area in a layout in which the screen area of the display is split into a plurality of areas including the first area and the second area, and
when the layout change of swapping the display of the first area and the display of the second area is performed by the screen layout change process, in the window rearrangement process, swap and rearrange a foremost first window out of the windows arranged in the first area and a foremost second window out of the windows arranged in the second area based on the position information for each window stored by the storage process before the layout change and the Z-order managed by the management process, and then rearrange the windows other than the first and second windows in order according to the Z-order managed by the management process.

7. The information processing apparatus according to claim 1, wherein
the processor is configured to:
by the screen layout change process, perform a change between a first layout in which an entire screen area of the display is used as the area in which the windows are displayable and a third layout in which the screen area of the display is split into a plurality of areas including a first area and a second area,
when changing the layout from the first layout to the third layout by the screen layout change process, in the window rearrangement process, minimize the windows other than a foremost window in each of the plurality of areas in the third layout, and
when the layout is changed from the third layout back to the first layout by the screen layout change process, unminimize the windows that are minimized in the third layout, and rearrange the windows based on the position information for each window stored by the storage process before changing the layout from the first layout to the third layout and the Z-order managed by the management process.

8. The information processing apparatus according to claim 1, wherein
the processor is configured to:
in the screen layout change process, perform a change between a first layout in which an entire screen area of the display is used as the area in which the windows are displayable and a third layout in which the screen area of the display is split into a plurality of areas, and
when changing the layout from the third layout to the first layout by the screen layout change process, in the window rearrangement process, rearrange the one or the plurality of windows in order according to the Z-order managed by the management process.

9. A control method in an information processing apparatus including a display, a memory configured to temporarily store a program of an application, and a processor configured to perform control of displaying windows of the application on the display by executing the program of the application stored in the memory,
the method comprising:
via the processor,
a screen layout change step of changing a layout of an area in which one or a plurality of the windows are displayable, within a screen area of the display;
a storage step of storing position information for each window before the layout of the screen area is changed by the screen layout change step;
a management step of managing a Z-order of the one or the plurality of windows arranged in the screen area of the display; and
a window rearrangement step of rearranging the one or the plurality of windows in order according to the Z-order managed by the management step, when rearranging the one or the plurality of windows based on the position information for each window stored by the storage step, after the layout of the screen area is changed by the screen layout change step.
